(19) United States
(12) Patent Application Publication
(10) Pub. No.: US 2025/0326049 A1
(43) Pub. Date: Oct. 23, 2025

(54) LASER MACHINING APPARATUS, CONTROL DEVICE, LASER MACHINING SYSTEM, AND LASER MACHINING METHOD

(71) Applicant: Mitsubishi Electric Corporation, Tokyo (JP)

(72) Inventors: Kyohei ISHIKAWA, Tokyo (JP); Kenta FUJII, Tokyo (JP); Hiroki MURAOKA, Tokyo (JP)

(73) Assignee: Mitsubishi Electric Corporation, Tokyo (JP)

(21) Appl. No.: 18/854,574

(22) PCT Filed: Apr. 12, 2022
(86) PCT No.: PCT/JP2022/017619

§ 371 Date: Oct. 7, 2024

(51) Int. Cl. B23K 26/046; B23K 26/06; B23K 26/36; B23K 26/70

(52) U.S. Cl. CPC B23K 26/046; B23K 26/0648; B23K 26/36; B23K 26/707

(57) ABSTRACT

A laser machining apparatus includes: a beam characteristic calculation unit that calculates a beam characteristic of laser light; an optical component temperature estimation unit that estimates an estimated temperature of an optical component based on the beam characteristic and temperature information; a thermal lens estimation unit that estimates a thermal lens amount of the optical component based on the estimated temperature; an imaging performance change estimation unit that estimates, based on the thermal lens amount, an estimated imaging performance change amount that is an amount of change in imaging performance of an imaging optical system of the machining head from before start of machining; a correction amount calculation unit that calculates a correction amount of a machining parameter based on the estimated imaging performance change amount; and a control unit that changes the machining parameter based on the correction amount during the laser machining.

### FIELD

The present disclosure relates to a laser machining apparatus that performs laser machining, a control device, a laser machining system, and a laser machining method.

### BACKGROUND

A laser machining apparatus that irradiates a workpiece with laser light to perform laser machining on the workpiece focuses the laser light on a specific position using an optical component included in the machining head, and irradiates the workpiece with the focused laser light. In such a laser machining apparatus, the optical component absorbs the laser light, resulting in thermal lensing in which the refractive index of the optical component changes. For this reason, in the laser machining apparatus, the imaging performance of the laser light changes, and a machining defect may occur as the machining proceeds despite good machining at the start of machining.

In the laser machining apparatus described in Patent Literature 1, a drive motor moves a lens in the optical axis direction in accordance with the lens temperature detected by a temperature sensor provided on the lens, thereby adjusting the focal position of the laser beam.

### CITATION LIST

### Patent Literature

Patent Literature 1: Japanese Patent Application Laid-open No. 2000-94173

### SUMMARY OF INVENTION

### Problem to be Solved by the Invention

However, in the technique of Patent Literature 1, since the lens is moved in the optical axis direction only in accordance with the lens temperature, it is not possible to consider a change in the imaging performance of the imaging optical system, which is problematic in that prevention/reduction of deterioration of laser machining quality is insufficient.

The present disclosure has been made in view of the above, and an object thereof is to obtain a laser machining apparatus capable of sufficiently preventing/reducing deterioration of laser machining quality.

### Means to Solve the Problem

In order to solve the above-described problems and achieve the object, a laser machining apparatus according to the present disclosure includes: a beam characteristic calculation unit that calculates a beam characteristic of laser light with which an optical component disposed in a machining head is irradiated; and a temperature estimation unit that estimates an estimated temperature of the optical component based on the beam characteristic and temperature information that is information on a temperature measured by a temperature sensor disposed in the machining head. In addition, the laser machining apparatus according to the present disclosure includes: a thermal lens estimation unit that estimates a thermal lens amount of the optical component based on the estimated temperature; and an imaging performance change estimation unit that estimates, based on the thermal lens amount, an estimated imaging performance change amount that is an amount of change in imaging performance of an imaging optical system of the machining head from before start of machining. In addition, the laser machining apparatus according to the present disclosure includes: a correction amount calculation unit that calculates a correction amount of a machining parameter based on the estimated imaging performance change amount; and a control unit that controls laser machining that uses the laser light, and changes the machining parameter based on the correction amount during the laser machining.

### Effects of the Invention

The laser machining apparatus according to the present disclosure can achieve the effect of sufficiently preventing/reducing deterioration of laser machining quality.

### BRIEF DESCRIPTION OF DRAWINGS

FIG. 1 is a diagram illustrating a configuration of a laser machining apparatus according to the first embodiment.

FIG. 2 is a diagram for explaining the arrangement configuration of an optical component included in the machining head of the laser machining apparatus according to the first embodiment.

FIG. 3 is a diagram for explaining thermal lensing that occurs in the laser machining apparatus according to the first embodiment.

FIG. 4 is a block diagram illustrating the functional configuration of the laser machining apparatus according to the first embodiment.

FIG. 5 is a flowchart illustrating a procedure for machining control by the machining control unit of the laser machining apparatus according to the first embodiment.

FIG. 6 is a block diagram illustrating the functional configuration of the laser machining apparatus according to the second embodiment.

FIG. 7 is a block diagram illustrating the functional configuration of the laser machining apparatus according to the third embodiment.

FIG. 8 is a block diagram illustrating the functional configuration of the laser machining apparatus according to the fourth embodiment.

FIG. 9 is a diagram illustrating an exemplary configuration of a neural network model according to the fourth embodiment.

FIG. 10 is a diagram illustrating an exemplary configuration of processing circuitry in the case that the processing circuitry provided in the machining control unit according to the first to fourth embodiments is implemented by a processor and a memory.

FIG. 11 is a diagram illustrating an example of processing circuitry in the case that the processing circuitry provided in the machining control unit according to the first to fourth embodiments is implemented by dedicated hardware.

### DESCRIPTION OF EMBODIMENTS

Hereinafter, a laser machining apparatus, a control device, a laser machining system, and a laser machining method according to embodiments of the present disclosure will be described in detail with reference to the drawings.

### First Embodiment

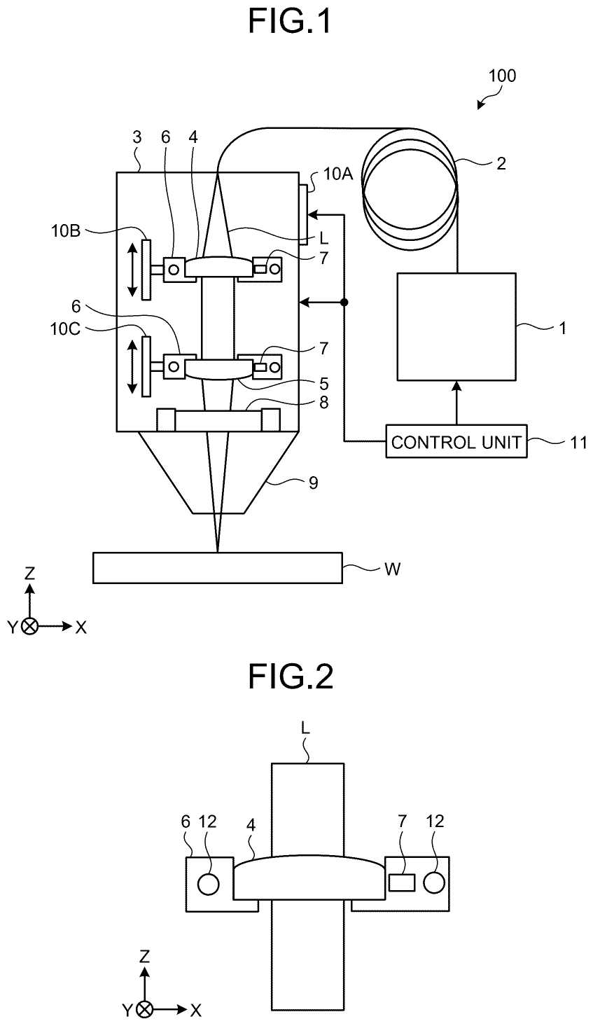

FIG. 1 is a diagram illustrating the configuration of a laser machining apparatus according to the first embodiment. Hereinafter, two axes orthogonal to each other on a plane parallel to the upper surface of a workpiece W that is a planar workpiece are referred to as the X axis and the Y axis. The axis orthogonal to the X axis and the Y axis is referred to as the Z axis. For example, the XY plane is a horizontal plane, and the Z-axis direction is a direction parallel to the vertical direction. The workpiece W is not limited to a planar shape.

The laser machining apparatus 100 is an apparatus that performs laser machining of the workpiece W by irradiating the workpiece W with laser light L that is a laser beam. The laser machining apparatus 100 focuses the laser light L using an optical component included in a machining head 3, and irradiates the workpiece W with the focused laser light L to machine the workpiece W.

The laser machining apparatus 100 includes a laser oscillator 1, a control unit 11, an optical fiber 2, and a machining head 3. The machining head 3 includes a collimator lens 4, an imaging optical system 5, two optical component holders 6, two temperature sensors 7, a protective glass 8, a machining nozzle 9, and drive units 10A to 10C which are motor drive devices.

The control unit 11 is connected to the laser oscillator 1 and the machining head 3, and controls the laser oscillator 1 and the machining head 3. The control unit 11 is disposed in a machining control unit 102 (not illustrated in FIG. 1) that is described later. The laser oscillator 1 oscillates the laser light L. The optical fiber 2 transmits the laser light L oscillated by the laser oscillator 1 and sends the laser light L into the machining head 3.

In the machining head 3, the optical component holder 6 disposed on the upper side supports the collimator lens 4, and the optical component holder 6 disposed on the lower side supports the imaging optical system 5. The temperature sensor 7 is disposed on each optical component holder 6.

The collimator lens 4 collimates the laser light L and sends the laser light L to the imaging optical system 5. The imaging optical system 5 forms an image of the laser light L at a specific position. The laser light L having passed through the imaging optical system 5 is sent to the machining nozzle 9 via the protective glass 8. The protective glass 8 protects components and the like disposed in the machining head 3 from splashes during laser machining.

The machining nozzle 9 irradiates the irradiation position on the workpiece W with the laser light L having passed through the protective glass 8. Machining gas is supplied into the machining head 3. When irradiating the workpiece W with the laser light L, the machining head 3 jets the machining gas to the workpiece W. The machining nozzle 9 has an opening on the optical path of the laser light L between the imaging optical system 5 and the workpiece W, and the laser light L and the machining gas pass through the opening.

A Z-axis motor (not illustrated) that moves the machining head 3 in the Z-axis direction and the drive unit 10A that drives the Z-axis motor are disposed in the laser machining apparatus 100. The Z-axis motor is connected to an axis (axis extending in the Z-axis direction) on which the machining head 3 is installed, and moves the machining head 3 in a direction parallel to the Z-axis direction along the Z-axis.

The laser machining apparatus 100 further includes an X-axis motor (not illustrated) and a Y-axis motor (not illustrated) that move the machining table (not illustrated) on which the workpiece W is placed on the XY plane, a drive unit (not illustrated) that drives the X-axis motor, and a drive unit (not illustrated) that drives the Y-axis motor. The X-axis motor is connected to an axis extending in the X-axis direction, and the Y-axis motor is connected to an axis extending in the Y-axis direction. The X-axis motor and the Y-axis motor move the machining table on the XY plane along the X-axis and the Y-axis.

The control unit 11 controls the laser oscillator 1, the machining head 3, the drive units 10A to 10C, and the like based on machining parameters, i.e. numerical parameters related to laser machining, to execute machining. For example, the control unit 11 controls the drive units 10A to 10C, and the drive units 10A to 10C drive the motors under the control of the control unit 11. The drive unit 10A operates as the motors operate, and changes the relative position between the machining head 3 and the workpiece W. FIG. 1 illustrates a case where the drive unit 10A moves the machining head 3 to change the relative position between the machining head 3 and the workpiece W.

The drive units 10B and 10C change the positional relationship between the imaging position of the laser light L with the imaging optical system 5 and the workpiece W. The drive unit 10B is a drive unit for the collimator lens 4, and changes the imaging diameter by the imaging optical system 5 by changing the position of the collimator lens 4. The drive unit 10C is a drive unit for the imaging optical system 5, and changes the imaging position by the imaging optical system 5 by changing the position of the imaging optical system 5.

The laser oscillator 1 can be of any type. An example of the laser oscillator 1 is a fiber laser oscillator that transmits the laser light L through the optical fiber 2. The laser oscillator 1 may be a direct diode laser, a carbon dioxide laser, a copper vapor laser, various ion lasers, or a solid laser that uses a Yttrium Aluminum Garnet (YAG) crystal or the like as an excitation medium. In addition, the laser machining apparatus 100 may include a wavelength conversion unit that converts the wavelength of the laser light L oscillated by the laser oscillator 1.

The number of collimator lenses 4 may be one or more. The number of imaging optical systems 5 may be one or more. The optical system disposed in the machining head 3 may be a zoom optical system that changes the imaging diameter of the imaging point by displacing the position of the optical system. The optical system disposed in the machining head 3 may be an optical system in which the drive unit displaces the collimator lens 4 to adjust the divergence angle of incidence on the imaging optical system 5, thereby displacing the imaging position. In addition, the imaging position that is changed by the drive unit 10C may be at the beam waist position of the optical system or may be a position deviated from the beam waist position.

The laser machining apparatus 100 may change the relationship between the position of the imaging point of the laser light L and the position of the workpiece W in the height direction without changing the relationship between the position of the machining nozzle 9 in the height direction and the position of the workpiece W in the height direction. In this case, the control unit 11 controls the drive unit 10C so that the drive unit 10C changes the position of the imaging optical system 5 in the height direction.

In the machining head 3, a drive unit other than the drive units 10B and 10C may drive an optical component other than the imaging optical system 5. The optical component that is driven by the machining head 3 may be of one type or a plurality of types. The optical components in the first embodiment are the collimator lens 4, the imaging optical system 5, and the protective glass 8, but an optical component such as a mirror may be disposed in the machining head 3.

With the above configuration, the laser light L emitted from the optical fiber 2 passes through the collimator lens 4, is imaged by the imaging optical system 5, and passes through the protective glass 8, whereby the workpiece W to be machined is irradiated therewith. Consequently, the workpiece W is machined by the laser light L.

Here, the arrangement configuration of an optical component included in the machining head 3 will be described. FIG. 2 is a diagram for explaining the arrangement configuration of an optical component included in the machining head of the laser machining apparatus according to the first embodiment. Here, the arrangement configuration of the collimator lens 4 will be described, but the arrangement configuration of the imaging optical system 5 is also similar to the arrangement configuration of the collimator lens 4.

As illustrated in FIG. 2, optical components such as the collimator lens 4 are held by the optical component holder 6 such as a lens holder which is an example of a holding unit. The holding unit includes a member that holds an optical component such as the optical component holder 6 that holds a lens such as the collimator lens 4 or a mirror holder (not illustrated) that holds a mirror (not illustrated).

In addition, the temperature sensor 7 is disposed on the optical component holder 6. Examples of the temperature sensor 7 include a thermocouple and a thermistor. As illustrated in FIG. 2, the optical component holder 6 may include a water passage 12 for cooling the optical component holder 6. In the case where the optical component holder 6 has the water passage 12, cooling water flows through the water passage 12 to cool the optical component. Note that the optical component holder 6 that holds the imaging optical system 5 may also be equipped with the water passage 12.

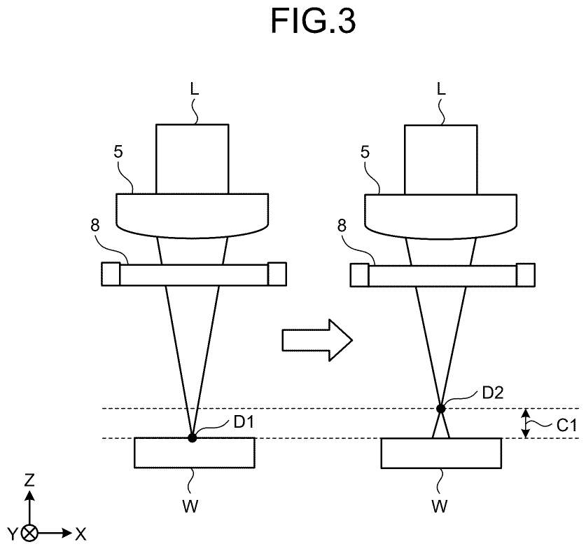

Next, the positional deviation of the imaging point due to thermal lensing, which is one of the factors of imaging performance change that occurs during laser machining, will be described. FIG. 3 is a diagram for explaining thermal lensing that occurs in the laser machining apparatus according to the first embodiment. In FIG. 3, the imaging point position D1 at the start of machining is illustrated on the left side, and the imaging point position D2 after the start of machining is illustrated on the right side.

In the laser machining apparatus 100, the glass material or coating of an optical component absorbs the laser light L oscillated by the laser oscillator 1 in a transmission optical system such as a lens or a reflection optical system such as a mirror. Consequently, in the laser machining apparatus 100, the refractive index (refractive index distribution) of the optical components changes, and thermal lensing occurs. In addition, the time during which a temperature distribution is formed in the optical component varies depending on the material of the optical component and the beam diameter of irradiation.

As illustrated in FIG. 3, in the laser machining apparatus 100, the imaging position of the laser light L at the imaging point may vary between the start of machining and after the start of machining. For example, as illustrated on the left side of FIG. 3, at the start of machining with the laser machining apparatus 100, the imaging point is located on the surface of the workpiece W, and good machining is performed. However, as the machining with the laser machining apparatus 100 progresses, the imaging position changes as illustrated on the right side of FIG. 3, and the imaging point moves in the direction of the machining head 3 from the surface of the workpiece W, so that machining defects may occur.

Note that the condition that ensures good machining is not limited to that the imaging point is on the workpiece W. Good machining can be ensured when the imaging point is not on the workpiece W but is located closer to the machining head 3, or when the imaging point is located on the depth direction side of the workpiece W.

In addition, the occurrence of thermal lensing may cause not only a change in the imaging position but also an imaging magnification, a beam waist position, an aberration, and the like, resulting in deterioration of the imaging performance of the entire machining optical system.

The laser machining apparatus 100 according to the first embodiment accurately estimates the temperature of the optical component by consideration of the temperature sensor 7 included in the machining head 3 even in a case where thermal lensing occurs. Then, the laser machining apparatus 100 accurately estimates the amount of change in imaging performance from before the start of machining (hereinafter referred to as the imaging performance change amount) based on the estimated temperature of the optical component, determines a correction amount of a machining parameter which depends on the imaging performance change amount, and corrects the machining parameter. Examples of machining parameters include the imaging magnification, the height of the machining nozzle 9 from the workpiece W (distance between the machining nozzle 9 and the workpiece W), the positional relationship between the imaging position of the imaging optical system 5 and the position of the workpiece W in the Z-axis direction, the positional relationship between optical components, the machining speed, the laser output value, the pulse frequency of the laser light L, the duty ratio of the pulse of the laser light L, the nozzle diameter, the type of laser beam mode, the positional relationship between the center of the nozzle hole and the laser beam, and the like.

Some of the machining parameters have a certain machining tolerance, such as cutting speed, imaging position, and laser output. Here, the machining tolerance refers to a range (change range of the machining parameter) in which the same machining quality can be achieved with the machining parameter changed.

Since the laser machining apparatus 100 according to the first embodiment corrects the machining parameters by consideration of even the change in the imaging performance of the imaging optical system 5, it is possible to sufficiently prevent/reduce deterioration of laser machining quality. In the laser machining apparatus 100, the temperature sensor 7 is attached to the holding unit (optical component holder 6) that holds the optical component. Consequently, the laser machining apparatus 100 can estimate the influence of heat transfer on the optical component caused by the purge gas contained in the machining head 3 and the cooling effect derived from the optical component holder 6. Therefore, the laser machining apparatus 100 can estimate a state change such as a temperature change in the machining head 3, and can estimate the imaging performance change amount in detail in real time.

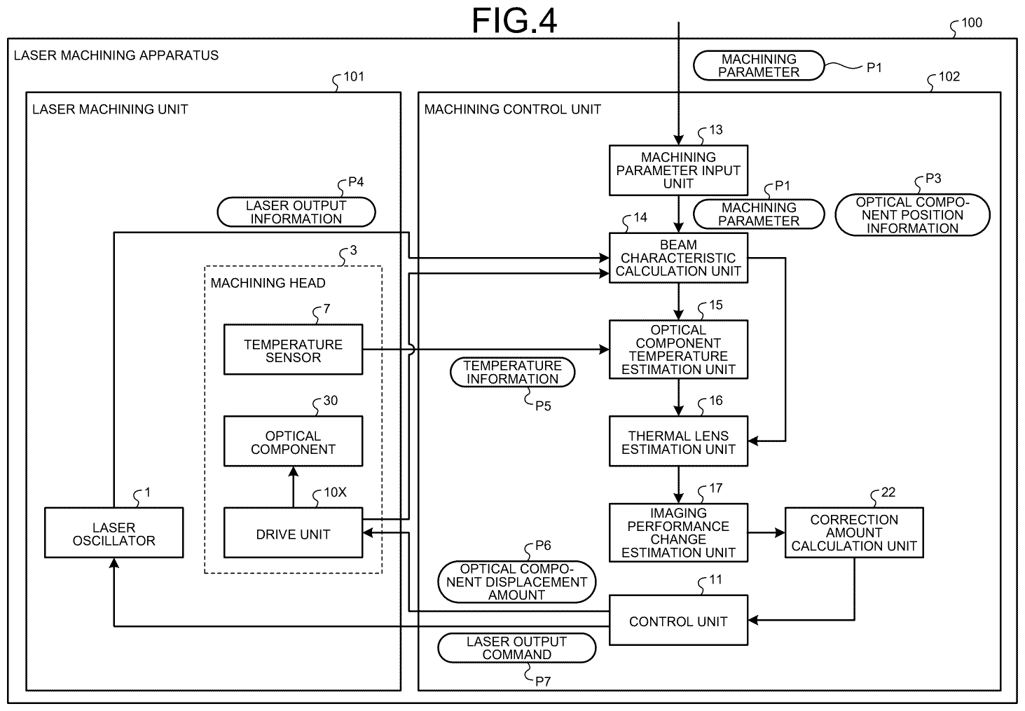

Next, the functional configuration of the laser machining apparatus 100 will be described. FIG. 4 is a block diagram illustrating the functional configuration of the laser machining apparatus according to the first embodiment. The laser machining apparatus 100 includes a laser machining unit 101 and the machining control unit 102 that is a control device. Note that the laser machining unit 101 and the machining control unit 102 may be connected via a network or the like.

The laser machining unit 101 includes the laser oscillator 1, the optical fiber 2 (not illustrated in FIG. 4), and the machining head 3. The machining head 3 includes the temperature sensor 7, an optical component 30, and a drive unit 10X. The optical component 30 is the collimator lens 4, the imaging optical system 5, or the like. The drive unit 10X is the drive unit 10B, 10C, or the like. In FIG. 4, illustration of the optical component holder 6, the protective glass 8, the machining nozzle 9, and the drive unit 10A is omitted.

The machining control unit 102 includes a machining parameter input unit 13, a beam characteristic calculation unit 14, an optical component temperature estimation unit 15, a thermal lens estimation unit 16, an imaging performance change estimation unit 17, a correction amount calculation unit 22, and the control unit 11.

The machining parameter input unit 13 receives a machining parameter P1 input from the outside of the laser machining apparatus 100 and outputs the machining parameter P1 to the beam characteristic calculation unit 14. Note that the machining parameter P1 received by the machining parameter input unit 13 and the machining parameter P1 corrected by the control unit 11 may be different machining parameters.

The beam characteristic calculation unit 14 receives the machining parameter P1 sent from the machining parameter input unit 13. In addition, the beam characteristic calculation unit 14 receives laser output information P4 sent from the output monitor mounted on the laser oscillator 1. The laser output information P4 is information indicating the output value of the laser light L.

The beam characteristic calculation unit 14 may extract the laser output information P4 from the machining parameter P1 output from the machining parameter input unit 13. In addition, the beam characteristic calculation unit 14 may calculate the laser output information P4 from a laser output command P7 actually output from the control unit 11 to the laser oscillator 1.

The beam characteristic calculation unit 14 extracts optical component position information P3 indicating the position of the optical component 30 from the machining parameter P1 received from the machining parameter input unit 13. The beam characteristic calculation unit 14 performs ray tracing using the laser output information P4 and the optical component position information P3, thereby calculating one or more beam characteristics from among the beam diameter, the incident angle, the emission angle from the optical component 30, and the beam intensity of the laser light L with which each optical component 30 is irradiated. The beam characteristic calculation unit 14 outputs the calculated beam characteristic to the optical component temperature estimation unit 15. In addition, the beam characteristic calculation unit 14 outputs the optical component position information P3 (lens position and the like) and the calculated beam diameter to the thermal lens estimation unit 16.

Note that the beam characteristic calculation unit 14 may calculate the optical component positional information P3 from a position command that the drive unit 10X actually outputs to the optical component 30 or the optical component holder 6.

In addition, the beam characteristic calculation unit 14 may calculate the optical component positional information P3 from a drive command (command for moving the optical component 30) that the control unit 11 actually outputs to the drive unit 10X. In addition, the beam characteristic calculation unit 14 may calculate the optical component positional information P3 from the imaging magnification, the height of the machining nozzle 9 from the workpiece W, the positional relationship between the imaging position and the workpiece W, and the like included in the machining parameter P1.

The optical component temperature estimation unit 15 receives the beam characteristic of each optical component 30 from the beam characteristic calculation unit 14, and receives temperature information P5 from the temperature sensor 7 disposed in the machining head 3. The temperature information P5 is information on the temperature of the optical component 30. The optical component temperature estimation unit 15 estimates the temperature distribution (estimated temperature) of the optical component 30 based on the received temperature information P5 and beam characteristic. Specifically, the optical component temperature estimation unit 15 estimates the temperature distribution of the optical component 30 by considering the heating effect due to absorption of the laser light L by the optical component 30, the cooling effect by the water passage 12 of the optical component holder 6, and the cooling effect of the atmosphere in the machining head 3. Note that the optical component temperature estimation unit 15 only needs to estimate the temperature of at least one point on the surface or inside of the optical component 30 for each of the optical components 30. The optical component temperature estimation unit 15 outputs the calculated temperature distribution of the optical component 30 to the thermal lens estimation unit 16. A method of calculating the temperature distribution will be described later.

The thermal lens estimation unit 16 estimates the thermal lens amount of each optical component 30 based on the information received from the optical component temperature estimation unit 15 and the information received from the beam characteristic calculation unit 14. Specifically, the thermal lens estimation unit 16 estimates the thermal lens amount of each optical component 30 based on the temperature distribution of the optical component 30, the optical component positional information P3, and the beam diameter. The thermal lens estimation unit 16 calculates the thermal lens amount as a virtual lens having a focal length. The thermal lens estimation unit 16 outputs the calculated thermal lens amount to the imaging performance change estimation unit 17.

The imaging performance change estimation unit 17 receives the thermal lens amount of each optical component 30 from the thermal lens estimation unit 16. The imaging performance change estimation unit 17 estimates the imaging performance change amount (estimated imaging performance change amount) on the workpiece W based on the thermal lens amount of each optical component 30. Specifically, the imaging performance change estimation unit 17 estimates the imaging performance change amount on the workpiece W by estimating the imaging performance change amount in view of the machining optical system of the machining head 3. The imaging performance change amount is the amount of change in imaging performance between before and after the start of machining.

That is, the imaging performance change amount here is based on the imaging performance at the start of machining. The time of the start of machining may refer to the time when the machining program starts, or the timing at which the laser output in the laser output information P4 becomes a specific value after a lapse of a specific period of time from the time when the laser output value in the laser output information P4 becomes 0 [W]. The imaging performance change estimation unit 17 outputs the estimated imaging performance change amount to the correction amount calculation unit 22.

The correction amount calculation unit 22 calculates a correction amount for returning the imaging performance to the state before the start of machining based on the received imaging performance change amount. The correction amount is, for example, a position correction amount for correcting the position of the optical component 30. In other words, the correction amount is a correction amount for correcting the imaging performance.

The correction amount calculation unit 22 outputs the calculated correction amount to the control unit 11. The control unit 11 controls the laser oscillator 1 and/or the machining head 3 based on the correction amount such that the imaging performance has a constant evaluation value. When controlling the laser oscillator 1, the control unit 11 outputs the laser output command P7 to the laser oscillator 1. When controlling the optical component 30 in the machining head 3, the control unit 11 outputs an optical component displacement amount P6 to the drive unit 10X. Note that the control unit 11 may adjust the position of the machining head 3 based on the correction amount such that the imaging performance has a constant evaluation value.

The control unit 11 outputs the optical component displacement amount P6 for controlling the position of the optical component 30 using, for example, the position command to the optical component 30 specified by the machining program and the correction amount of the position command of the optical component 30. The optical component displacement amount P6 includes a command for controlling the position of the collimator lens 4, a command for controlling the position of the imaging optical system 5, and the like.

In addition, the control unit 11 outputs the laser output command P7 for controlling the laser output of the laser oscillator 1 using, for example, the output command of the laser light L to the laser oscillator 1 specified by the machining program and the correction amount of the output command of the laser light L. The laser output command P7 includes the laser output value, the pulse frequency of the laser light L, the duty ratio of the pulse of the laser light L, the type of laser beam mode, and the like.

The evaluation value of imaging performance increases as the change amount of the position of the imaging point from the start of machining decreases. That is, the evaluation value of imaging performance is the amount of change in the position of the imaging point with respect to the time of the start of machining. Therefore, by the control unit 11 adjusting the position of the optical component 30 such that the imaging performance has a constant evaluation value, the imaging performance at the start of machining is maintained.

Note that the control unit 11 may maintain good machining by adjusting machining parameters other than the machining parameter P1 adjusted to correct the imaging performance. The control unit 11 need not necessarily adjust the machining parameter P1 such that the imaging performance has a constant evaluation value, and may adjust the machining parameter P1 such that the evaluation value falls within a specific range. The specific range is, for example, the tolerance of the amount of change in the imaging position in the case of the imaging position.

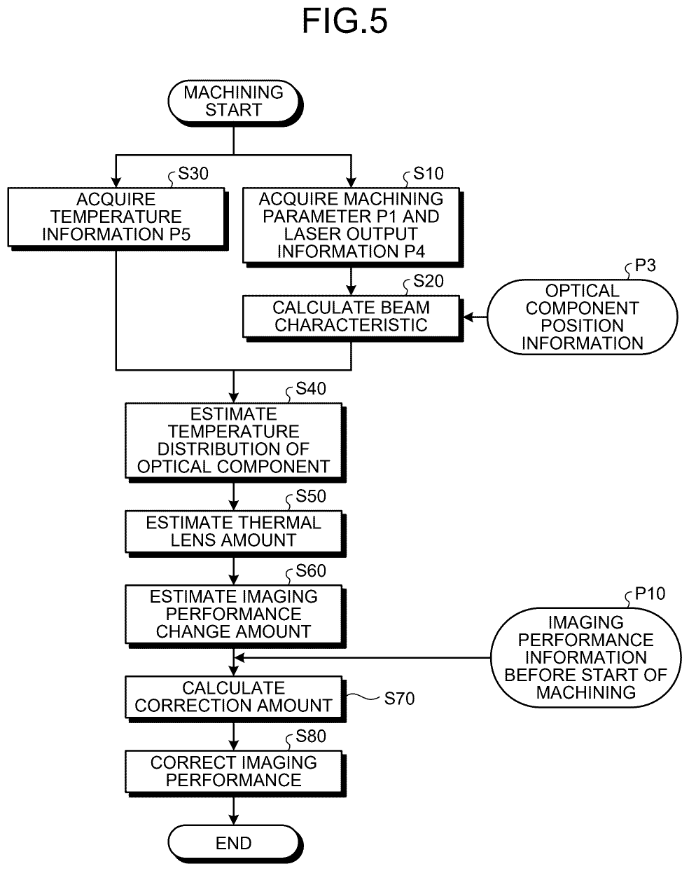

FIG. 5 is a flowchart illustrating a procedure for machining control by the machining control unit of the laser machining apparatus according to the first embodiment. The beam characteristic calculation unit 14 acquires the machining parameter P1 and the laser output information P4 (step S10). Specifically, the beam characteristic calculation unit 14 acquires the machining parameter P1 from the machining parameter input unit 13, and acquires the laser output information P4 from the output monitor mounted on the laser oscillator 1.

The beam characteristic calculation unit 14 extracts optical component position information P3 indicating the position of the optical component 30 from the machining parameter P1 acquired from the machining parameter input unit 13. The beam characteristic calculation unit 14 performs ray tracing using the laser output information P4 and the optical component position information P3, thereby calculating a beam characteristic of the laser light L with which each optical component 30 is irradiated (step S20). The beam characteristic calculation unit 14 sends the calculated beam characteristic to the optical component temperature estimation unit 15.

The optical component temperature estimation unit 15 acquires the beam characteristic of each optical component 30 from the beam characteristic calculation unit 14, and acquires the temperature information P5 from the temperature sensor 7 disposed in the machining head 3 (step S30). Note that the process in which the optical component temperature estimation unit 15 acquires the temperature information P5 may be executed before the process in step S20 or may be executed before the process in step S10.

The optical component temperature estimation unit 15 estimates the temperature distribution of the optical component 30 based on the acquired temperature information P5 and beam characteristic (step S40). The optical component temperature estimation unit 15 sends the calculated temperature distribution to the thermal lens estimation unit 16.

The thermal lens estimation unit 16 estimates the thermal lens amount of each optical component 30 based on the temperature distribution received from the optical component temperature estimation unit 15 (step S50). The thermal lens estimation unit 16 transmits the estimated thermal lens amount of each optical component 30 to the imaging performance change estimation unit 17.

The imaging performance change estimation unit 17 estimates the imaging performance change amount on the workpiece W based on the thermal lens amount of each optical component 30 received from the thermal lens estimation unit 16 (step S60). The imaging performance change estimation unit 17 sends the estimated imaging performance change amount to the correction amount calculation unit 22.

The correction amount calculation unit 22 calculates a correction amount for correcting the imaging performance based on the imaging performance change amount received from the imaging performance change estimation unit 17 (step S70). The correction amount calculation unit 22 outputs the correction amount to the control unit 11. The control unit 11 corrects the imaging performance by outputting the position command corresponding to the correction amount to the laser machining unit 101 (step S80). Note that the control unit 11 may output the position command corresponding to the correction amount to the drive unit 10X or to the drive unit 10A.

Here, a laser machining apparatus according to a comparative example will be described. In the laser machining apparatus according to the comparative example, for example, a temperature sensor provided in a lens in the machining head detects the lens temperature, and the focal position is adjusted based on the lens temperature. In the case of the laser machining apparatus according to the comparative example, since it is not possible to estimate the influence of the atmosphere in the machining head, it is difficult to accurately adjust the focal position. In addition, in the case of the laser machining apparatus according to the comparative example, since the influence of the laser output cannot be considered, the amount of change in the imaging position during laser machining cannot be reflected in the control of focusing. For this reason, deterioration of the machining quality of laser machining due to the change in the imaging performance of the imaging optical system is not prevented/reduced, and the machining quality cannot be maintained.

On the other hand, in the first embodiment, the machining control unit 102 estimates the change in the imaging performance of the imaging optical system 5 based on the laser output information P4, the optical component position information P3, and the temperature information P5, and corrects the imaging position, so that the imaging position can be accurately adjusted.

Here, a method of estimating the temperature of the optical component 30 by the optical component temperature estimation unit 15 will be described. Here, as an example for obtaining the temperature distribution of the optical component 30, a method of obtaining the temperatures of two points in the optical component 30 will be described.

Given that the absorption rate of the laser light L in one optical component 30 is a, the mass of the optical component 30 is m [kg], the specific heat is c [J/kg·K], the laser output radiated to the optical component 30 is P, t is a time constant, and (i) is a calculation step at an increment time, the temperature rise dT(i) of the optical component 30 irradiated with the laser light L at the increment time dt can be approximated by Formula (1) below.

$$\begin{matrix}Formula 1 & \\ dT ( i ) = α P ( i ) * ( 1 / mc ) dt / τ & ( 1 )\end{matrix}$$

Since the absorption rate a, the mass m, and the specific heat c are constants, a, m, and c may be expressed as one constant for simplification of management of calculation parameters. In addition, since the time constant t varies depending on the beam diameter of the laser light L that is radiated, the optical component temperature estimation unit 15 changes the time constant t according to the beam diameter calculated by the beam characteristic calculation unit 14. In addition, the optical component temperature estimation unit 15 may change the time constant t according to the machining parameter P1 such as the imaging magnification.

In addition, since the temperature rise dT(i) of the optical component 30 also varies depending on the position of the optical component 30, the optical component temperature estimation unit 15 may estimate the temperature rise dT(i) of the optical component 30 using a polynomial for the position of the optical component 30 or using a value approximate to the beam intensity distribution of the laser light L. When it is difficult to approximate the beam intensity distribution, the beam intensity distribution may be manually set as a fixed value. Here, a temperature rise component due to beam absorption at the beam center in the i-th step among time steps is denoted by dTp_{center}(i), and a temperature rise component at the beam end is denoted by dTp_{edge}(i).

Next, the cooling effect of the optical component 30 by water cooling of the water passage 12 included in the optical component holder 6 will be described. The temperature of the optical component holder 6 output by the temperature sensor 7 is denoted by temperature T_{H}. In the machining head 3, heat is transferred between the optical component holder 6 and the position of the beam end of the laser light L at the optical component 30. Therefore, given that the temperature of the beam end is T_{edge}, a parameter related to temperature such as thermal resistance is k_{w}, and the time constant is τ_{Q}, the relationship between T_{edge}, which is the temperature of the beam end, and the temperature change component dT_{c}(i) of cooling from the optical component holder 6 can be approximated as Formula (2) below.

$$\begin{matrix}Formula 2 & \\ {dT}_{c} ( i ) = {k}_{w} ( {T}_{edge} ( i - 1 ) - {T}_{H} ( i - 1 ) ) dt / {τ}_{w} & ( 2 )\end{matrix}$$

In addition, in a case where the optical component holder 6 does not have the water passage 12 such as a cooling structure, parameter k_{w}=0 may be set so that the cooling effect of water cooling is not expressed.

The temperature change component of the purge gas corresponding to the cooling effect of the purge gas in the machining head 3 (the effect of cooling from the gas purging inside the machining head 3) can be approximated as Formulas (3) and (4) below using a parameter kg related to the temperature of the beam center and a parameter kg_{edge} related to the temperature of the beam end, where the temperature of the purge gas is T_{g} and the temperature of the beam center is T_{center}.

$$\begin{matrix}Formula 3 & \\ {dT}_{cgcenter} ( i ) = kg ( {T}_{g} - {T}_{center} ( i - 1 ) ) dt & ( 3 )\end{matrix}$$

$$\begin{matrix}Formula 4 & \\ {dT}_{cgedge} ( i ) = {kg}_{edge} ( {T}_{g} - {T}_{edge} ( i - 1 ) ) dt & ( 4 )\end{matrix}$$

dT_{cgcenter}(i) in Formula (3) is the temperature change component of the beam center, and dT_{cgedge}(i) in Formula (4) is the temperature change component of the beam end. T_{g} may be the value of the temperature sensor 7 of the optical component holder 6 before machining, or may be a value directly measured by a temperature sensor (not illustrated) disposed near the optical path in the machining head 3. In addition, T_{g} may be a value calculated based on a value measured by the temperature sensor 7 during laser machining and a structure in the machining head 3. Since the purge gas directly cools the optical component 30, the optical component temperature estimation unit 15 may approximate the temperature change component of the purge gas without having the time constant T. Here, the temperature T_{center}(i) of the beam center can be expressed by Formula (5) below. In addition, the temperature T_{edge}(i) of the beam end can be expressed by Formula (6) below.

$$\begin{matrix}Formula 5 & \\ {T}_{center} ( i ) = {T}_{center} ( i - 1 ) + {dTp}_{center} ( i - 1 ) + {dT}_{cgcenter} ( i - 1 ) & ( 5 )\end{matrix}$$

$$\begin{matrix}Formula 6 & \\ {T}_{edge} ( i ) = {T}_{edge} ( i - 1 ) + {dT}_{edge} ( i - 1 ) + {dT}_{cw} ( i - 1 ) + {dT}_{cgedge} ( i - 1 ) & ( 6 )\end{matrix}$$

Here, ΔT(i), which is a difference between T_{center}(i) and T_{edge}(i), can be expressed by Formula (7) below.

$$\begin{matrix}Formula 7 & \\ Δ T ( i ) = {T}_{center} ( i ) - {T}_{edge} ( i ) & ( 7 )\end{matrix}$$

The optical component temperature estimation unit 15 may use ΔT(i) expressed by Formula (7) as the temperature distribution. In addition, the temperature distribution of the optical component 30 is not limited to the beam center and the beam end, and may additionally include a temperature estimation point between the beam center and the beam end. The optical component temperature estimation unit 15 can estimate a more detailed temperature distribution as the number of temperature estimation points increases.

In addition, the optical component temperature estimation unit 15 may estimate the temperature distribution by additionally considering other cooling components. The optical component temperature estimation unit 15 may estimate the temperature distribution by consideration of, for example, heat exchange between the beam center and the beam end, that is, the influence of thermal radiation of the machining head 3.

In addition, if there is no problem in considering the temperature distribution as a change in the temperature information at a certain point of the optical component 30, the optical component temperature estimation unit 15 may estimate only the temperature difference at this point as the temperature distribution (change in the temperature information P5).

When the laser oscillator 1 oscillates a pulse faster than the processing speed of the optical component temperature estimation unit 15, the beam characteristic calculation unit 14 calculates the laser output [W], which is the laser output information P4, as the average output during the processing of the optical component temperature estimation unit 15.

In the above description, the optical component temperature estimation unit 15 refers only to the value one step before by increment time, but the optical component temperature estimation unit 15 may refer to the value a plurality of steps before. When the signal-to-noise (SN) ratio of the temperature sensor 7 is poor, the optical component temperature estimation unit 15 may use a value obtained by averaging temperatures (temperatures at a plurality of points) measured by the temperature sensor 7 over a plurality of times during a specific period of time as the temperature measured by the temperature sensor 7.

Formulas (1) to (4) in the first embodiment have described first-order approximation of heat conduction equations in terms of time. However, if it is necessary to more accurately approximate the heat transfer characteristic of the temperature, a parameter related to the temperature may be set after higher-order approximation.

In addition, when the temperature is calculated based on Formulas (1) to (4), the temperature is calculated by integrating Formulas (1) to (4) with time. Note that the integration method is not limited to the method of integrating Formulas (1) to (4) with time, and Runge-Kutta methods or the like may be used.

The parameters and the time constant t in the optical component temperature estimation unit 15 are obtained in advance and set in the optical component temperature estimation unit 15. The parameters and the time constant τ in the optical component temperature estimation unit 15 may be obtained in advance for each position of the optical components 30 or may be obtained in advance for each machining parameter P1. In addition, the parameters and the time constant τ in the optical component temperature estimation unit 15 may be determined by a user such as an operator when the machining control unit 102 is started, or may be determined by the manufacturer of the machining control unit 102 at the time of shipment.

In addition, the parameters of the optical component temperature estimation unit 15 may be determined by an operator, may be determined using machine learning such as Bayesian search, or may be determined by grid search, random search, or the like. The imaging performance is experimentally measured, and the parameters are determined such that the value estimated by the imaging performance change estimation unit 17 matches the measured value.

In addition, in a case where the optical component 30 deteriorates over time, there is a possibility that the absorption rate a of the laser light L by the optical component 30 increases. Therefore, the parameter of the absorption rate a may be changed according to the use period of the optical component 30. Thus, the machining parameter P1 can be adjusted in accordance with the degree of deterioration of the machining head 3.

Next, a method of calculating the thermal lens amount by the thermal lens estimation unit 16 will be described. The focal length f of the thermal lens of the optical component 30 can be expressed by Formula (8) below.

$$\begin{matrix}Formula 8 & \\ f = \frac{2 {r}^{2}}{OPD} & ( 8 )\end{matrix}$$

In Formula (8), r is the beam radius, and Optical Path Difference (OPD) is the optical path difference between the ray passing through the end of the beam and the ray passing through the center of the beam. The OPD is generated due to the temperature dependency dn/dT of the refractive index of the optical component 30 and the linear expansion coefficient dl/dT.

Note that the thermal lens estimation unit 16 may calculate the optical path difference using ΔT obtained by optical component temperature estimation unit 15. In this case, assuming that the refractive index of the optical component 30 is n and the thickness of the optical component 30 is 1, the thermal lens estimation unit 16 can calculate the OPD, namely optical path difference, with Formula (9) below.

$$\begin{matrix}Formula 9 & \\ OPD = ( \frac{dn}{dT} l + \frac{dl}{dT} n ) Δ T & ( 9 )\end{matrix}$$

The thermal lens estimation unit 16 can calculate the focal length f of the thermal lens of each optical component 30 by calculating the OPD. In addition, the thermal lens estimation unit 16 may compare any values of the temperature dependency dn/dT and the linear expansion coefficient dl/dT, and if one of them is extremely small (if the difference or ratio is equal to or less than a specific value), the smaller term may be eliminated to perform approximation.

If the optical component temperature estimation unit 15 has obtained the temperature of the optical component 30 at a plurality of points, the thermal lens estimation unit 16 may obtain the focal length f of the thermal lens after obtaining a plurality of focal lengths f. The thermal lens estimation unit 16 outputs the calculated focal length f of the thermal lens to the imaging performance change estimation unit 17 as thermal lens information of the optical component 30.

The imaging performance change estimation unit 17 estimates the imaging performance change amount on the workpiece W by estimating the evaluation value of imaging performance in view of the entire optical system of the machining head 3. The imaging performance change estimation unit 17 may estimate the imaging performance change amount through ray tracing or paraxial ray tracing using a ray matrix or the like. Consequently, the imaging performance change estimation unit 17 can estimate the imaging performance change amount during the laser machining, and can output the imaging performance change amount to the control unit 11 during the laser machining.

The laser machining apparatus 100 compares the position of the imaging point before machining with the position of the imaging point after machining to calculate the imaging performance change amount generated during the laser machining, and corrects the machining parameter P1 by the imaging performance change amount. Consequently, the laser machining apparatus 100 can accurately estimate the positional deviation amount of the imaging point and accurately correct the positional deviation amount of the imaging point. Therefore, the laser machining apparatus 100 can execute machining with the stable machining parameter P1, and thus machining defects can be prevented/reduced. That is, the laser machining apparatus 100 can prevent/reduce deterioration of laser machining quality.

In a case where the workpiece W is a metal or the like to be machined using the high-output laser light L, the laser machining apparatus 100 can further prevent/reduce deterioration of laser machining quality by correcting the machining parameter P1 according to the change in imaging performance.

In addition, the laser machining apparatus 100 estimates the imaging performance by the use of only the information (machining parameter P1) input to the machining parameter input unit 13, the information (temperature information P5) obtained from the temperature sensor 7 in the machining head 3, and the information (laser output information P4) obtained from the laser oscillator 1. Therefore, the laser machining apparatus 100 can estimate the imaging performance robustly with respect to external factors that occur during laser machining, such as changes in the material of the workpiece W and the temperature of the workpiece W.

When estimating the temperature of the optical component 30, the laser machining apparatus 100 estimates the temperature of the optical component 30 in time series by consideration of the value one step before by increment time. That is, the optical component temperature estimation unit 15 estimates the temperature of the optical component 30 for a plurality of time points in time series, and estimates the temperature of the optical component 30 based on the temperature at a time point at least one step before the time point of estimation. Consequently, the laser machining apparatus 100 can consider the temperature value at the time point of a near calculation step before the temperature estimation time step of the optical component 30, so that the calculation processing can be reduced, and the temperature can be accurately estimated even under fluctuations in the output of the laser light L. That is, the laser machining apparatus 100 can accurately estimate the temperature of the optical component 30 according to the change in the output of the laser light L, and allows for easy calculation processing. Note that the laser machining apparatus 100 may estimate the temperature of the optical component 30 by consideration of the value a plurality of steps before as long as the calculation load is not affected.

The control unit 11 may move the position of the optical component 30 so as to correct the cause of deterioration if the deterioration of the imaging performance affects machining. The priority order of correction against the change in imaging performance due to thermal lensing may be determined by an operator. In addition, the control unit 11 may change the machining parameter P1 such as the positional relationship of the optical component 30 according to the priority order of correction. For example, in the case of setting to preferentially correct the amount of change in the imaging position, the control unit 11 may correct the imaging position by moving the position of the imaging optical system 5. In addition, in the case of setting to preferentially correct the aberration, the control unit 11 may correct the aberration by moving at least one of the collimator lens 4 and the imaging optical system 5. In addition, the control unit 11 may set the imaging performance as one evaluation value by weighting the amount of change in the imaging position, the aberration amount, and the like, and adjust the machining parameter P1 such that the imaging performance has a constant evaluation value.

In addition, the laser machining apparatus 100 may estimate the influence of the purge gas included in the machining head 3 and the influence of heat transfer to the optical component 30 by the optical component holder 6. In this case, the optical component temperature estimation unit 15 estimates a state change such as a change in the temperature of the machining head 3 by estimating the temperature of at least one point on the surface or inside of the optical component 30 for each of the optical components 30. Consequently, the optical component temperature estimation unit 15 can estimate the imaging performance change amount in detail in real time.

The temperature sensor 7 of the optical component holder 6 and the water passage 12 can have any positional relationship. The temperature sensor 7 only needs to be able to measure the influence of the temperature by the water passage 12. The temperature sensor 7 may be disposed in the atmosphere of the machining head 3. In this case, the optical component temperature estimation unit 15 may directly estimate the temperature of the purge gas.

In addition, in a case where not all the optical component holders 6 are equipped with the temperature sensor 7, the laser machining apparatus 100 may estimate the temperature of the optical component 30 that does not have the temperature sensor 7 by the use of information of the temperature sensor 7 disposed at a position close to this optical component 30.

In addition, the laser machining apparatus 100 may estimate the temperature of the optical component 30 that does not have the temperature sensor 7 based on information on the configuration of the optical component holder 6 and/or the temperature information P5 obtained from the optical component 30 having a close irradiation beam diameter.

In addition, in a case where the temperature sensor 7 is not mounted on the optical component 30 having a small change in ray like the protective glass 8, the laser machining apparatus 100 may set the absorption rate a of the laser light L at the optical component 30 disposed in the previous stage or the optical component 30 disposed in the subsequent stage to be twice so as to omit calculation for the component not equipped with the temperature sensor 7.

In addition, in a case where one optical component holder 6 includes a plurality of optical components 30, such as assembled lenses, the laser machining apparatus 100 may perform processing such as multiplying the absorption rate α of the laser light L by the number of assembled lenses.

In order to correct the imaging performance change amount during laser machining, the control unit 11 commands the drive unit 10X to change the machining parameter P1 such as the positional relationship of the optical component 30 and the displacement amount of the optical component 30 (such as the curvature of the mirror). The term “during laser machining” may refer to the period in which the laser light L that machines one component oscillates, or the period in which the oscillation of the laser light L suspends while one component is machined. The period in which the oscillation of the laser light L suspends while one component is machined is, for example, a period in which machining switching is performed, such as switching from drilling such as piercing to cutting. The control unit 11 commands the drive unit 10X to change the machining parameter P1 during the laser machining to adjust the imaging performance.

In addition, during execution of a program for cutting out a large number of components from one workpiece W, the control unit 11 may move the optical component 30 while the machining head 3 is moving to machine the next component. In addition, the control unit 11 may move the optical component 30 until a specific period of time elapses after the output of the laser light L becomes zero.

In addition, the control unit 11 may change the timing of changing the machining parameter P1 for each control period of the control unit 11, or may change the timing when the machining head 3 reaches a specific movement amount. Here, the value of the specific movement amount may vary depending on the machining parameter P1 or the material to be machined. As described above, by correcting the imaging performance during laser machining, the laser machining apparatus 100 can perform machining without changing the machining quality on a component that takes time to machine due to a large workpiece W or the like.

In addition, in a case where the value of the temperature information P5 from the temperature sensor 7 is higher than a specific value, and a machining defect is likely to occur even after correction of the imaging performance, there is a possibility that the optical component 30 has damage, and thus, the control unit 11 may output a command to stop the machining or the like to the laser machining unit 101. Consequently, the laser machining apparatus 100 can detect continuous occurrence of the machining defect during laser machining and prevent the machining defect from continuing.

The laser machining described in the first embodiment may be any machining such as cutting, welding, drilling, and stacking. The raw material of the workpiece W to be subjected to the laser machining may be any raw material such as metal and resin.

As described above, the laser machining apparatus 100 according to the first embodiment estimates the estimated temperature (temperature distribution) of the optical component 30 based on the beam characteristic of the laser light L with which the optical component 30 disposed in the machining head 3 is irradiated and the temperature information P5 measured by the temperature sensor 7 disposed in the machining head 3. In addition, the laser machining apparatus 100 estimates the thermal lens amount of the optical component 30 based on the temperature distribution, and estimates the imaging performance change amount based on the thermal lens amount. The laser machining apparatus 100 calculates the correction amount of the machining parameter P1 based on the estimated imaging performance change amount, and changes the machining parameter P1 based on the correction amount during laser machining. Consequently, since the laser machining apparatus 100 can execute laser machining in consideration of even the change in the imaging performance of the imaging optical system 5, it is possible to sufficiently prevent/reduce deterioration of laser machining quality. In addition, since the laser machining apparatus 100 estimates the amount of change in imaging performance, it is possible to perform correction without considering the value of the absolute value of the machining parameter P1.

### Second Embodiment

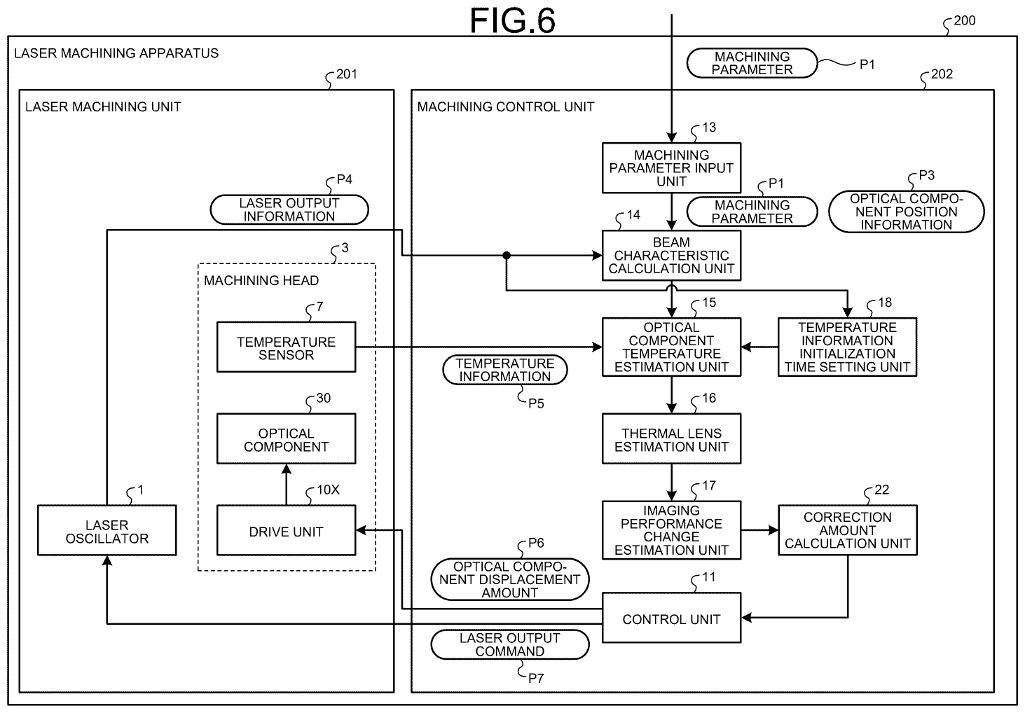

Next, the second embodiment will be described with reference to FIG. 6. In the second embodiment, when the time during which the laser output value is 0 [W] continues for a specific period of time or more, there is a high possibility that the temperature of the purge gas has changed, and thus the temperature information of the purge gas is updated.

FIG. 6 is a block diagram illustrating the functional configuration of the laser machining apparatus according to the second embodiment. Components illustrated in FIG. 6 that achieve the same functions as those of the laser machining apparatus 100 of the first embodiment illustrated in FIG. 4 are denoted by the same reference signs, and duplicate descriptions are omitted.

The laser machining apparatus 200 includes a laser machining unit 201 and a machining control unit 202. The laser machining unit 201 has the same configuration as the laser machining unit 101. The machining control unit 202 includes a temperature information initialization time setting unit 18 in addition to the components included in the machining control unit 102.

The temperature information initialization time setting unit 18 is connected to the optical component temperature estimation unit 15. The optical component temperature estimation unit 15 according to the second embodiment is connected to the laser oscillator 1 and acquires the laser output information P4 from the output monitor mounted on the laser oscillator 1.

When executing laser machining, the laser machining apparatus 200 may produce a plurality of identical or different components from one large workpiece W. In this case, in the laser machining apparatus 200, the temperature of the purge gas in the machining head 3 used in the optical component temperature estimation unit 15 may have not been cooled yet or may have been completely cooled.

Because the imaging performance change amount varies depending on the temperature of the purge gas, the laser machining apparatus 200 according to the second embodiment updates the initial temperature of the purge gas based on the output state of the laser light L that affects the temperature of the purge gas. The initial temperature of the purge gas is a temperature that is used for calculating the temperature change component dT_{ogcenter}(i) of the beam center and the temperature change component dT_{ogedge}(i) of the beam end described above. Consequently, the temperature change component dT_{ogcenter}(i) of the beam center and the temperature change component dT_{ogedge}(i) of the beam end described above have appropriate values that depend on the temperature of the purge gas.

The temperature information initialization time setting unit 18 updates the initial temperature of the purge gas and/or the initial temperature of the ambient temperature of the machining head 3 when the timing at which the laser light L is not oscillated, that is, the time during which the laser output value is 0 [W], continues for a specific period of time or more. For example, when the time during which the laser output value is 0 [W] continues for a specific period of time or more, the temperature information initialization time setting unit 18 outputs a command (initial temperature update command) to update the initial temperature of the purge gas and the initial temperature of the ambient temperature of the machining head 3 to the optical component temperature estimation unit 15. Note that the temperature information initialization time setting unit 18 may output an initial temperature update command to the optical component temperature estimation unit 15 when a state in which the laser output value is near 0 [W] (less than a specific value) continues for a specific period of time or more.

As described above, if the laser output value is less than a specific value (for example, 0 [W]) during the set specific period of time, the temperature information initialization time setting unit 18 outputs, to the optical component temperature estimation unit 15, an initial temperature update command to update the temperature of the purge gas stored in the optical component temperature estimation unit 15 to the latest value of the temperature information P5 output by the temperature sensor 7 at this time (time when the initial temperature update command is received).

Upon receiving the initial temperature update command, the optical component temperature estimation unit 15 updates the currently stored temperature of the purge gas to the latest value of the temperature information P5 output by the temperature sensor 7 at the time of reception of the initial temperature update command. Then, the optical component temperature estimation unit 15 estimates the temperature distribution of the optical component 30 based on the updated temperature information P5 and the beam characteristic received from the beam characteristic calculation unit 14.

Consequently, the laser machining apparatus 200 can also cope with temperature change of the purge gas in the machining head 3, temperature change of the surrounding environment, and the like, and can perform machining after estimating the imaging performance adapted to the environment. Note that the time setting of the temperature information initialization for the temperature information initialization time setting unit 18 may be set by an operator, may be set in advance at the time of startup of the machining control unit 202, or may be set at the time of shipment of the machining control unit 202.

In addition, the temperature information initialization time setting unit 18 may have a function of initializing the imaging performance change amount changed through thermal lensing, such as initializing the deviation amount of the imaging position to 0 [mm] when the time during which the laser output value is 0 [W] continues for a specific period of time. Consequently, since the laser machining apparatus 200 does not displace the optical component 30 unless it actually contributes to machining, it is possible to prolong the life of the drive unit 10X.

As described above, in the second embodiment, when the time during which the laser output value is 0 [W] continues for a specific period of time or more, there is a high possibility that the temperature of the purge gas has changed, and thus the laser machining apparatus 200 updates the temperature information of the purge gas. Consequently, the laser machining apparatus 200 can accurately estimate the state of the atmosphere in the machining head 3 before the start of machining. Therefore, the laser machining apparatus 200 can perform machining after estimating the imaging performance that depends on the temperature change of the purge gas in the machining head 3, the temperature change of the surrounding environment, and the like. Therefore, the laser machining apparatus 200 can sufficiently prevent/reduce deterioration of laser machining quality.

### Third Embodiment

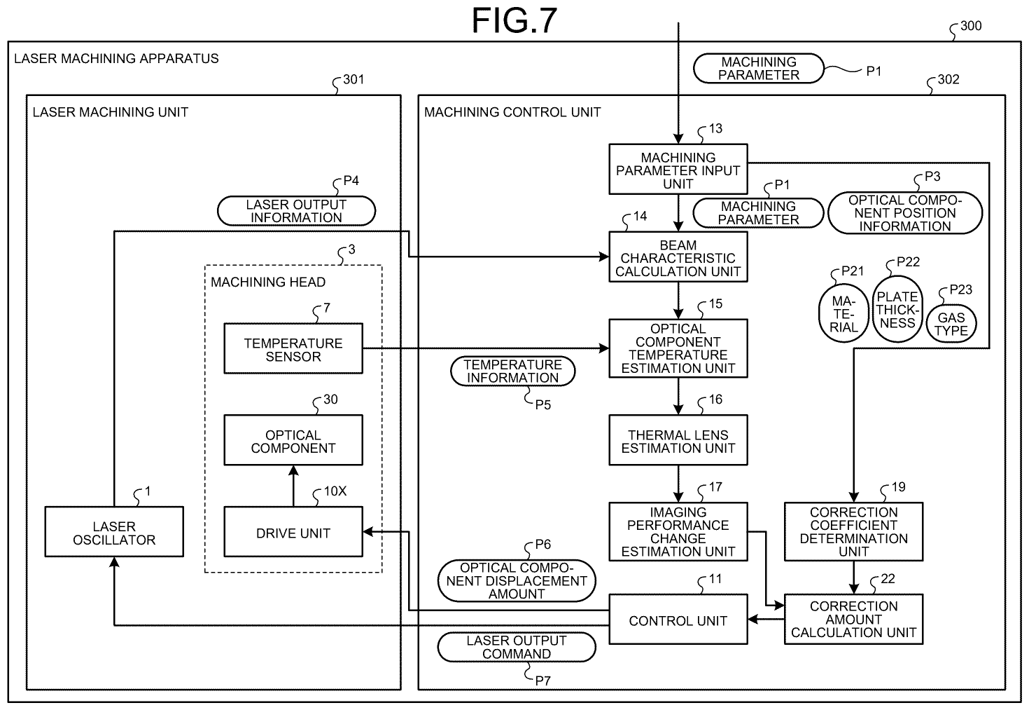

Next, the third embodiment will be described with reference to FIG. 7. The laser machining apparatus according to the third embodiment corrects the imaging performance change amount estimated by the imaging performance change estimation unit 17 based on machining type information indicating the type of laser machining such as the material and plate thickness of the workpiece W and the type of machining gas.

FIG. 7 is a block diagram illustrating the functional configuration of the laser machining apparatus according to the third embodiment. Components illustrated in FIG. 7 that achieve the same functions as those of the laser machining apparatus 100 of the first embodiment illustrated in FIG. 4 are denoted by the same reference signs, and duplicate descriptions are omitted.

The laser machining apparatus 300 includes a laser machining unit 301 and a machining control unit 302. The laser machining unit 301 has the same configuration as the laser machining unit 101. The machining control unit 302 includes a correction coefficient determination unit 19 in addition to the components included in the machining control unit 102 or the components included in the machining control unit 202. Hereinafter, a case where the machining control unit 302 includes the correction coefficient determination unit 19 in addition to the components included in the machining control unit 102 will be described.

The machining parameter input unit 13 of the machining control unit 302 extracts, from the machining parameter P1, information indicating the material of the workpiece W (material P21), information indicating the plate thickness of the workpiece W (plate thickness P22), and information on the type of machining gas used for laser machining (gas type P23), and outputs the extracted information to the correction coefficient determination unit 19. The machining gas used for laser machining is gas (assist gas) sprayed onto the workpiece W when the workpiece W is irradiated with the laser light L.

The correction coefficient determination unit 19 is connected to the machining parameter input unit 13 and the correction amount calculation unit 22. The correction coefficient determination unit 19 receives the material P21, the plate thickness P22, and the gas type P23 from the machining parameter input unit 13 as machining type information. The correction coefficient determination unit 19 determines a correction coefficient k corresponding to at least one of the material P21, the plate thickness P22, and the gas type P23. The correction coefficient k is a coefficient for correcting the imaging performance change amount. The correction coefficient determination unit 19 outputs the determined correction coefficient k to the correction amount calculation unit 22.

The correction amount calculation unit 22 receives the correction coefficient k from the correction coefficient determination unit 19 and receives the imaging performance change amount from the imaging performance change estimation unit 17. Setting the imaging performance change amount estimated by the imaging performance change estimation unit 17 as the deviation amount Δf of the imaging position, the correction amount calculation unit 22 calculates the corrected deviation amount Δf_{corr} by multiplying Δf by the correction coefficient k for correcting Δf. Specifically, the correction amount calculation unit 22 calculates the deviation amount Δf_{corr} after correction using Formula (10) below.

$$\begin{matrix}Formula 10 & \\ Δ {f}_{corr} = k Δ f & ( 10 )\end{matrix}$$

The correction amount calculation unit 22 calculates a correction amount for returning the imaging performance to the state before the start of machining based on the deviation amount Δf_{corr} after correction (imaging performance change amount after correction). The correction amount calculation unit 22 outputs the calculated correction amount to the control unit 11.

In the laser machining apparatus 300, it may be known in advance whether the machining tolerance of the imaging position at the start of machining according to the material P21, the plate thickness P22, and the gas type P23 is positioned in the direction of the machining head 3 or the depth direction of the workpiece W relative to the surface of the workpiece W. In this case, the laser machining apparatus 300 can multiply the deviation amount Δf by the correction coefficient k that depends on the machining tolerance of the imaging position.

For example, for a cutting process in which the machining material is soft steel SS400 and the gas type P23 is oxygen, it is allowable to set the correction coefficient k that moves the imaging position of the imaging point in the direction of the machining head 3. Therefore, in this case, for example, a value of 1.0 or less is set as the correction coefficient k that avoids moving the imaging position of the imaging point in the depth direction of the workpiece W.

In addition, for a cutting process in which the gas type P23 is nitrogen, the setting of the correction coefficient k that moves the imaging position of the imaging point in the direction of the machining head 3 is avoided. Therefore, in this case, since it is allowed to move the imaging position of the imaging point in the depth direction of the workpiece W, for example, a value of 1.0 or more is set as the correction coefficient k.

Consequently, the laser machining apparatus 300 can correct the imaging performance according to the machining type information such as the material P21, the plate thickness P22, and the gas type P23, and can perform machining according to the work environment.

The correction amount calculation unit 22 calculates the correction amount of the machining parameter P1 based on the corrected imaging performance change amount (deviation amount Δf_{corr} after correction). The correction amount calculation unit 22 outputs the correction amount of the machining parameter P1 to the control unit 11. The control unit 11 adjusts the optical component 30 based on the correction amount such that the imaging performance has a constant evaluation value. The control unit 11 inputs a command for adjusting the optical component 30 (such as a movement command for the optical component 30) to the drive unit 10X, thereby controlling the laser machining while changing the position of the optical component 30 during the laser machining. In this manner, the control unit 11 executes the control corresponding to the evaluation value of imaging performance (imaging performance change amount) multiplied by the correction coefficient k.

As described above, in the third embodiment, the laser machining apparatus 300 corrects the imaging performance change amount in accordance with the material P21, the plate thickness P22, and the gas type P23. Consequently, the laser machining apparatus 300 can perform machining after correcting the machining parameter P1 with the correction amount corresponding to the imaging performance change amount corrected according to the material P21, the plate thickness P22, and the gas type P23. Therefore, the laser machining apparatus 300 can sufficiently prevent/reduce deterioration of laser machining quality.

### Fourth Embodiment

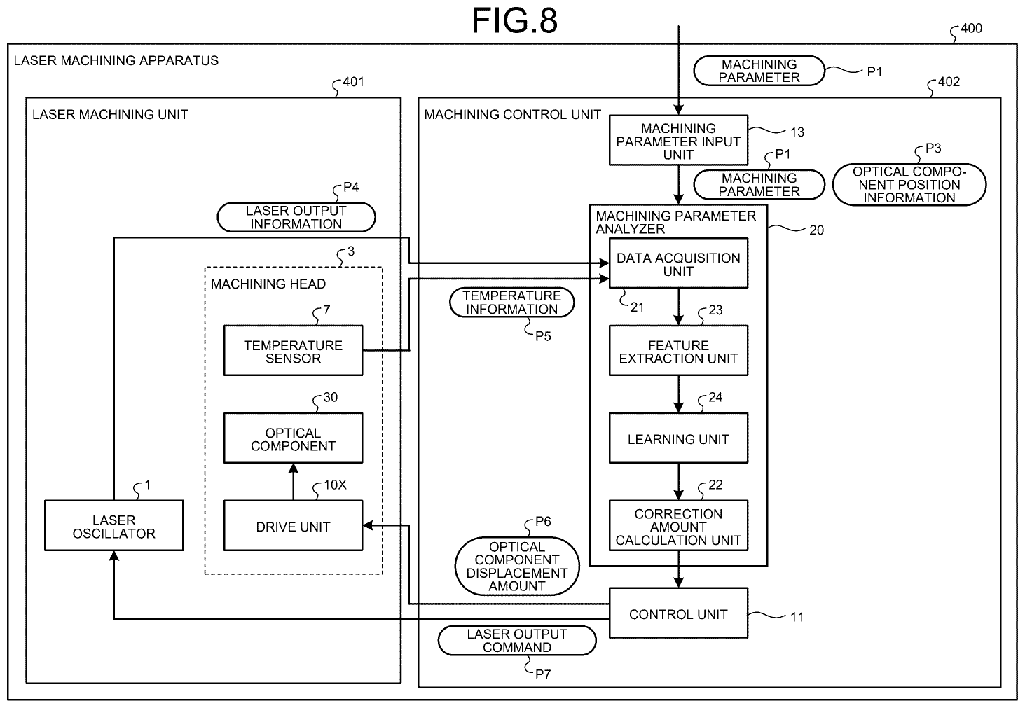

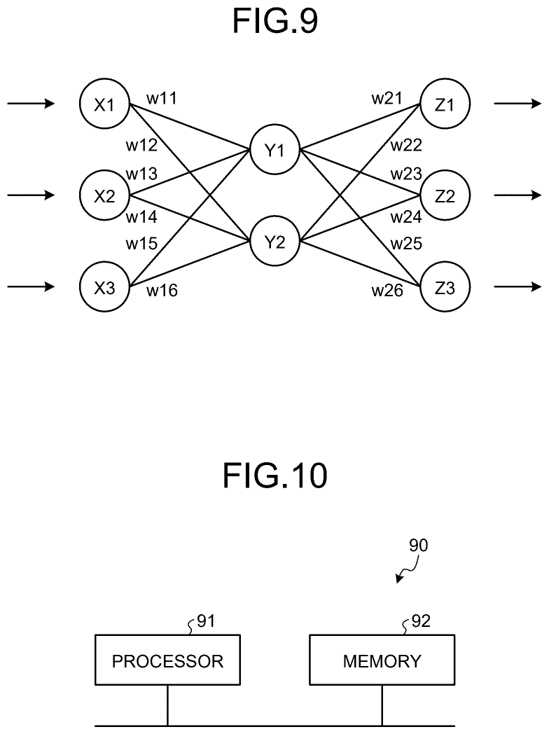

Next, the fourth embodiment will be described with reference to FIGS. 8 and 9. In the fourth embodiment, the laser machining apparatus creates a trained model by learning the correspondence relationship between the machining parameter P1, the optical component position information P3, the laser output information P4, and the temperature information P5 and the imaging performance change amount. Then, at the time of laser machining, the laser machining apparatus inputs the machining parameter P1, the optical component position information P3, the laser output information P4, and the temperature information P5 to the trained model to estimate the imaging performance change amount.

FIG. 8 is a block diagram illustrating the functional configuration of the laser machining apparatus according to the fourth embodiment. Components illustrated in FIG. 8 that achieve the same functions as those of the laser machining apparatus 100 of the first embodiment illustrated in FIG. 4 are denoted by the same reference signs, and duplicate descriptions are omitted.

The laser machining apparatus 400 includes a laser machining unit 401 and a machining control unit 402. The laser machining unit 401 has the same configuration as the laser machining unit 101. The machining control unit 402 includes a machining parameter analyzer 20 which is a machine learning device in addition to the components included in the machining control unit 102, the components included in the machining control unit 202, or the components included in the machining control unit 302. Hereinafter, a case where the machining control unit 402 includes the machining parameter analyzer 20 in addition to the components included in the machining control unit 102 will be described.

The machining parameter analyzer 20 includes a data acquisition unit 21, a feature extraction unit 23, a learning unit 24, and a correction amount calculation unit 22. The data acquisition unit 21 is connected to the machining parameter input unit 13, the laser oscillator 1, the temperature sensor 7, and the feature extraction unit 23. The learning unit 24 is connected to the feature extraction unit 23 and the correction amount calculation unit 22.

The data acquisition unit 21 acquires the machining parameter P1 and the optical component positional information P3 from the machining parameter input unit 13. The data acquisition unit 21 also acquires the temperature information P5 from the temperature sensor 7. In addition, the data acquisition unit 21 acquires the laser output information P4 from the laser oscillator 1. Here, the laser output information P4 is a first output value of the laser light L, and the temperature information P5 is first temperature information.

As in the first embodiment, the data acquisition unit 21 may extract the laser output information P4 from the machining parameter P1 output from the machining parameter input unit 13. In addition, the data acquisition unit 21 may calculate the laser output information P4 from the output command of the laser light L actually output from the control unit 11 to the laser oscillator 1.

In addition, the data acquisition unit 21 acquires a laser output history which is time-series data of laser output, and a temperature history which is time-series data of measurement results of the temperature sensor 7. Specifically, the data acquisition unit 21 generates a laser output history based on the laser output information P4. In addition, the data acquisition unit 21 generates a temperature history based on the temperature information P5.

The laser output history is a temporal transition of laser output. The laser output history may be the average output or peak output of the laser light L. The laser output history may be any data from which a temporal transition of output can be known. The data acquisition unit 21 acquires the laser output history in a sampling period that can be obtained by the data acquisition unit 21.

The data acquisition unit 21 outputs the acquired machining parameter P1, optical component positional information P3, laser output history, and temperature history to the feature extraction unit 23 as state quantities. The data acquisition unit 21 only needs to acquire first state quantities including at least the laser output information P4 and the temperature information P5 and output the first state quantities to the feature extraction unit 23. In addition, the data acquisition unit 21 may output state quantities including the laser output information P4 to the feature extraction unit 23 instead of the laser output history. In addition, the data acquisition unit 21 may output state quantities including the temperature information P5 to the feature extraction unit 23 instead of the temperature history.

The feature extraction unit 23 extracts features from the state quantities. The features here are information on the temperature of the optical component 30, information on the laser output, the machining parameter P1, and the like. The feature extraction unit 23 outputs the extracted features to the learning unit 24. The features correspond to the beam characteristic and the temperature information P5 described in the first to third embodiments.

In addition, the evaluation value of imaging performance is also input to the learning unit 24. The evaluation value of imaging performance is a value corresponding to the measurement result on the amount of change in the imaging point, and may be a continuous value or a discrete value. To the learning unit 24, the evaluation value of imaging performance determined by the operator may be input, or the evaluation value of imaging performance calculated by the imaging performance change estimation unit 17 in the first to third embodiments may be input. The evaluation value of imaging performance determined by the operator may be input from input means (not illustrated) or may be received from another device, for example. The evaluation value may be the beam waist position, the beam diameter at the imaging position, the spherical aberration amount, or the like. The evaluation value may be the quality of the shape of the beam intensity distribution.

The learning unit 24 learns the features extracted by the feature extraction unit 23 and the evaluation value of imaging performance in association with each other. That is, the learning unit 24 learns processes executed by the optical component temperature estimation unit 15, the thermal lens estimation unit 16, and the imaging performance change estimation unit 17. Note that the learning unit 24 is implemented by processing circuitry similarly to the machining parameter analyzer 20.

The learning unit 24 generates a trained model by learning a set of input data and result data through machine learning. Here, the learning unit 24 generates a trained model by learning to estimate the correction amount of the machining parameter P1 based on the state quantities. Any algorithm may be used as the algorithm of machine learning by the learning unit 24. The learning unit 24 can use, for example, a supervised learning algorithm.

The learning unit 24 performs machine learning of the imaging performance change amount (amount of change in imaging position, amount of change in aberration amount, and the like) by using a data set including features and evaluation values. The data set here is data in which features and evaluation values are associated with each other.

The learning unit 24 uses the machine-learning trained model to estimate a change in the machining parameter P1 that depends on the features, such as the position of the imaging point and the displacement amount of the positional relationship of the optical component 30 included in the machining head 3. Specifically, the learning unit 24 derives the imaging performance change amount that depends on the features using the trained model. That is, the learning unit 24 acquires second state quantities including at least the laser output information (second output value) P4 and the temperature information (first temperature information) P5 during the laser machining, and derives the imaging performance change amount corresponding to the second state quantities by inputting the features (second state quantities) to the trained model. The learning unit 24 outputs the derived imaging performance change amount to the correction amount calculation unit 22.

Note that the machining parameter analyzer 20 may not include the feature extraction unit 23. In this case, the data acquisition unit 21 outputs the state quantities to the learning unit 24. Then, the learning unit 24 executes learning using the state quantities instead of the features.

The correction amount calculation unit 22 calculates the correction amount of the machining parameter P1 based on the imaging performance change amount (estimated amount) sent from the learning unit 24. Note that the correction amount calculation unit 22 may acquire the machining parameter P1 set in the control unit 11, and calculate the correction amount based on the imaging performance change amount sent from the learning unit 24 and the machining parameter P1 currently set in the control unit 11. The correction amount calculation unit 22 outputs the calculated correction amount to the control unit 11.

The control unit 11 corrects the machining parameter P1 based on the correction amount received from the correction amount calculation unit 22, thereby controlling machining. As described above, when there is a difference between the value of the machining parameter P1 corresponding to the estimation result (imaging performance change amount) obtained by the learning unit 24 and the current value of the machining parameter P1, the laser machining apparatus 400 performs machining under a condition in which the machining parameter P1 is corrected. The correction of the machining parameter P1 is repeated until the correction amount (correction amount corresponding to the deviation amount of the imaging performance change amount) output from the learning unit 24 falls within a specific range. In the laser machining apparatus 400, the control unit 11 outputs a command corresponding to the correction amount to the drive unit 10X, so that the machining parameter P1 can be adjusted with high accuracy. When the correction amount is a correction amount for correcting the position of the machining head 3, the control unit 11 outputs a command corresponding to the correction amount to the drive unit 10A.

In the fourth embodiment, the machining parameter analyzer 20 learns the relationship between features and the deviation amount of the imaging performance change amount, but the machining parameter analyzer 20 may learn the relationship between features and the thermal lens amount. That is, the machining parameter analyzer 20 may learn processes executed by the optical component temperature estimation unit 15 and the thermal lens estimation unit 16. In other words, in the laser machining apparatuses 100, 200, and 300, the data acquisition unit 21, the feature extraction unit 23, and the learning unit 24 may be disposed as a machine learning device instead of the optical component temperature estimation unit 15 and the thermal lens estimation unit 16. In this case, the machine learning device receives the beam characteristic from the beam characteristic calculation unit 14 and receives the temperature information P5 from the temperature sensor 7. Then, the machine learning device generates a trained model indicating the correspondence relationship between features (beam characteristic and temperature information P5) and the thermal lens amount through learning. In this case, the thermal lens amount calculated by the operator is input to the machine learning device. The machine learning device estimates the thermal lens amount corresponding to features by inputting the features to the trained model at the time of laser machining. In this manner, the machine learning device learns the relationship between features and the thermal lens amount of the optical component 30, and estimates the thermal lens amount corresponding to the features instead of the optical component temperature estimation unit 15 and the thermal lens estimation unit 16 during laser machining.

In addition, the machining parameter analyzer 20 may learn the relationship between features and the temperature distribution of the optical component 30. That is, the machining parameter analyzer 20 may learn processes executed by the optical component temperature estimation unit 15. In other words, in the laser machining apparatuses 100, 200, and 300, the data acquisition unit (first data acquisition unit) 21, the feature extraction unit 23, and the learning unit (first learning unit) 24 may be disposed as a machine learning device (first machine learning device) instead of the optical component temperature estimation unit 15. In this case, the machine learning device receives a first beam characteristic from the beam characteristic calculation unit 14 and receives the temperature information (first temperature information) P5 from the temperature sensor 7. Then, the machine learning device generates a first trained model indicating the correspondence relationship between features (first state quantities including the beam characteristic and the temperature information P5) and the temperature distribution of the optical component 30 through learning. In this case, the temperature distribution of the optical component 30 calculated by the operator is input to the machine learning device. At the time of laser machining, the machine learning device inputs second state quantities including a second beam characteristic received from the beam characteristic calculation unit 14 and the temperature information (second temperature information) P5 received from the temperature sensor 7 to the first trained model, thereby estimating the temperature distribution of the optical component 30 corresponding to the second state quantities. In this manner, the machine learning device learns the relationship between features and the temperature distribution of the optical component 30, and estimates the temperature distribution of the optical component 30 corresponding to the features instead of the beam characteristic calculation unit 14 during laser machining.

In addition, the machining parameter analyzer 20 may learn the correspondence relationship between the temperature distribution estimated by the optical component temperature estimation unit 15, the optical component position information P3 sent from the beam characteristic calculation unit 14, and the beam diameter and the thermal lens amount. That is, the machining parameter analyzer 20 may learn processes executed by the thermal lens estimation unit 16. In other words, in the laser machining apparatuses 100, 200, and 300, the data acquisition unit (second data acquisition unit) 21, the feature extraction unit 23, and the learning unit (second learning unit) 24 may be disposed as a machine learning device (second machine learning device) instead of the thermal lens estimation unit 16. In this case, the machine learning device receives the temperature distribution (first estimated temperature) from the optical component temperature estimation unit 15. Then, the machine learning device generates a second trained model indicating the correspondence relationship between features (third state quantities including the temperature distribution estimated by the optical component temperature estimation unit 15) and the thermal lens amount through learning. In this case, the thermal lens amount calculated by the operator is input to the machine learning device. At the time of laser machining, the machine learning device inputs fourth state quantities including the temperature distribution (second estimated temperature) estimated by the optical component temperature estimation unit 15 to the second trained model, thereby estimating the thermal lens amount corresponding to the fourth state quantities. In this manner, the machine learning device learns the relationship between the temperature distribution, the optical component positional information P3, and the beam diameter and the thermal lens amount of the optical component 30, and estimates the thermal lens amount corresponding to the features instead of the thermal lens estimation unit 16 during laser machining. Note that the third state quantities and the fourth state quantities may include the optical component positional information P3 and the beam diameter sent from the beam characteristic calculation unit 14.

In addition, the machining parameter analyzer 20 may learn the correspondence relationship between the thermal lens amount estimated by the thermal lens estimation unit 16 and the imaging performance change amount or the evaluation value of imaging performance. That is, the machining parameter analyzer 20 may learn processes executed by the imaging performance change estimation unit 17. In other words, in the laser machining apparatuses 100, 200, and 300, the data acquisition unit (third data acquisition unit) 21, the feature extraction unit 23, and the learning unit (third learning unit) 24 may be disposed as a machine learning device (third machine learning device) instead of the imaging performance change estimation unit 17. In this case, the machine learning device receives the thermal lens amount (first thermal lens amount) from the thermal lens estimation unit 16. Then, the machine learning device generates a third trained model indicating the correspondence relationship between features (fifth state quantities including the thermal lens amount that is estimated by the thermal lens estimation unit 16) and the imaging performance change amount or the evaluation value of imaging performance through learning. In this case, the imaging performance change amount or the evaluation value of the imaging performance calculated by the operator is input to the machine learning device. At the time of laser machining, the machine learning device inputs sixth state quantities including the thermal lens amount (second thermal lens amount) estimated by the thermal lens estimation unit 16 to the third trained model, thereby estimating the imaging performance change amount or the evaluation value of imaging performance corresponding to the sixth state quantities. In this manner, the machine learning device learns the relationship between the thermal lens amount and the imaging performance change amount or the evaluation value of imaging performance, and estimates the imaging performance change amount or the evaluation value of imaging performance corresponding to the features instead of the imaging performance change estimation unit 17 during laser machining.

In addition, the machining parameter analyzer 20 may learn the correspondence relationship between the imaging performance change amount estimated by the imaging performance change estimation unit 17 and the correction amount of the machining parameter P1. That is, the machining parameter analyzer 20 may learn processes executed by the correction amount calculation unit 22. In other words, in the laser machining apparatuses 100, 200, and 300, the data acquisition unit (fourth data acquisition unit) 21, the feature extraction unit 23, and the learning unit (fourth learning unit) 24 may be disposed as a machine learning device (fourth machine learning device) instead of the correction amount calculation unit 22. In this case, the machine learning device receives the imaging performance change amount (first estimated imaging performance change amount) from the imaging performance change estimation unit 17. Then, the machine learning device generates a fourth trained model indicating the correspondence relationship between features (seventh state quantities including the imaging performance change amount estimated by the imaging performance change estimation unit 17) and the correction amount of the machining parameter P1 through learning. In this case, the correction amount of the machining parameter P1 calculated by the operator is input to the machine learning device. At the time of laser machining, the machine learning device inputs eighth state quantities including the imaging performance change amount (second estimated imaging performance change amount) estimated by the imaging performance change estimation unit 17 to the fourth trained model, thereby estimating the correction amount of the machining parameter P1 corresponding to the eighth state quantities. In this manner, the machine learning device learns the relationship between the imaging performance change amount and the correction amount, and estimates the correction amount corresponding to the features instead of the correction amount calculation unit 22 during laser machining.

Similarly, the machine learning device may learn the correspondence relationship between the thermal lens amount estimated by the thermal lens estimation unit 16 and the correction amount of the machining parameter P1. Similarly, the machine learning device may learn the correspondence relationship between the temperature distribution estimated by the optical component temperature estimation unit 15 and the correction amount of the machining parameter P1.

The machine learning device learns at least one of processes executed by the optical component temperature estimation unit 15, processes executed by the thermal lens estimation unit 16, processes executed by the imaging performance change estimation unit 17, and processes executed by the correction amount calculation unit 22. For example, the machine learning device may learn the correspondence relationship between the temperature distribution estimated by the optical component temperature estimation unit 15 and the imaging performance change amount.

The fourth embodiment has described the case where the learning unit 24 has both the learning function of performing machine learning on the relationship between features and the imaging performance change amount and the inference function of inferring the imaging performance change amount using the trained model. However, the learning function and the inference function may be implemented by separate devices. In other words, an inference unit that outputs an evaluation value using the trained model may be provided separately from the learning unit 24. That is, the machining parameter analyzer 20 may include an inference unit that calculates the imaging performance change amount using the trained model learned by the learning unit 24.

In the example illustrated in FIG. 8, the learning unit 24 is provided in the machining parameter analyzer 20, but the learning unit 24 may be a device different from the machining parameter analyzer 20. For example, the machining parameter analyzer 20 and the learning unit 24 may be connected via a network. Alternatively, the learning unit 24 may exist on a cloud server.

The learning unit 24 learns the imaging performance change amount corresponding to the machining parameter P1 and the laser output information P4 through what is called supervised learning by the use of, for example, a neural network model. Here, supervised learning is a type of machine learning that provides a large number of data sets that are input-result (label) data pairs to a learning instrument to learn features in those data sets and estimate results from inputs.

A neural network includes an input layer composed of a plurality of neurons, an intermediate layer composed of a plurality of neurons and also called a hidden layer, and an output layer composed of a plurality of neurons. The number of intermediate layers may be one, or may be two or more.

FIG. 9 is a diagram illustrating an exemplary configuration of a neural network model according to the fourth embodiment. X1, X2, and X3 are neurons of the input layer, Y1 and Y2 are neurons of the intermediate layer, and Z1, 22, and Z3 are neurons of the output layer. For example, in the case of a three-layer neural network model as illustrated in FIG. 9, when each of the three input values is input to the corresponding one of X1, X2, and X3, each input value is multiplied by the corresponding weights w11 to w16 and input to Y1 and Y2, which are neurons of the intermediate layer. Then, the output values from Y1 and Y2 are multiplied by the corresponding weights w21 to w26 and input to Z1, 22, and Z3, which are neurons of the output layer. The output layer adds the input values and outputs the resultant value as an output result. For example, the results output from Z1, 22, and Z3 can be made to correspond to the evaluation results corresponding to the respective machining defect items. The output results vary depending on the values of the weights w11 to w16 and the weights w21 to w26.

In the fourth embodiment, learning is performed by adjusting the weights w11 to w16 and the weights w21 to w26 using the data set described above such that the output result of the neural network approaches the correct evaluation result (imaging performance change amount) of imaging performance. Note that the neural network illustrated in FIG. 9 is an example, and the number of layers of the neural network model and the number of neurons belonging to each layer are not limited to the example of FIG. 9.

The learning unit 24 can also learn the relationship between the laser output information P4 and information of the temperature sensor 7 and the evaluation result of imaging performance or the machining parameter P1 to be corrected through what is called unsupervised learning using a neural network model. Unsupervised learning is a technique for providing a large amount of input data alone to the learning unit 24 to learn how the input data are distributed and learn the method of performing compression, classification, shaping, or the like on the input data without corresponding training output data. For example, in unsupervised learning, it is possible to cluster sets of input data having similar features. In this case, it is possible to implement prediction of evaluation results by assigning evaluation results to the results of clustering or the like so as to optimize the results of clustering or the like with respect to some kind of criterion. A type of problem setting intermediate between unsupervised learning and supervised learning is what is called semi-supervised learning, in which some data are input-output pairs and the remaining data are inputs alone. The learning unit 24 according to the fourth embodiment may implement machine learning through semi-supervised learning.

In addition, the learning unit 24 may acquire data sets from a plurality of machining parameter analyzers 20, and learn the evaluation result of imaging performance for a combination of a laser output history and a temperature history that is time-series data of measurement results (temperature information P5) of the temperature sensor 7. The plurality of machining parameter analyzers 20 may be the machining parameter analyzers 20 according to the fourth embodiment.

Note that the learning unit 24 may acquire data sets from a plurality of machining parameter analyzers 20 that are used at the same site, or may acquire data sets from a plurality of machining parameter analyzers 20 that operate at different sites. Further, it is also possible to add a new machining parameter analyzer 20 to the list of machining parameter analyzers from which data sets are acquired, or remove some machining parameter analyzer 20 from the list.

In addition, a learning unit may be provided separately from the machining parameter analyzer 20, and after learning with a data set acquired from a certain machining parameter analyzer (first machining parameter analyzer), the learning unit may be connected to another machining parameter analyzer (second machining parameter analyzer) and further acquire a data set from the second machining parameter analyzer to perform relearning.

The data acquisition unit 21 may also acquire the plate thickness P22 of the workpiece W, the material P21 of the workpiece W, and the like and include them in the state quantities. In this case, the feature extraction unit 23 outputs the features including the plate thickness P22 of the workpiece W, the material P21 of the workpiece W, and the like to the learning unit 24.

A learning algorithm for use in the learning unit 24 can be deep learning, which learns feature extraction directly. Alternatively, the learning unit 24 may execute machine leaning according to other known methods such as genetic programming, functional logic programming, support vector machines, Fisher's discriminant, subspace, and discrimination analysis using Mahalanobis' space, for example. In addition, as a learning algorithm for use in the learning unit 24, decision tree, random forest, logistic regression, k-nearest neighbor (kNN), subspace, class-featuring information compression method (CLAFIC), isolation forest, local outer factor (LOF), boosting, AdaBoost, LogitBoost, a one-class support vector machine (SVM), a Gaussian mixture model, or the like may be used. In addition, in a case where the learning unit 24 performs learning to automatically extract features, such as deep learning, convolutional neural network (CNN), recurrent neural network (RNN), or the like, the feature extraction unit 23 may not be provided. For the machining control unit 402, the machining parameter analyzer 20 may be provided for each item of imaging performance, or one machining parameter analyzer 20 may correspond to items of imaging performance. The learning unit 24 may search for parameters using a search algorithm such as reinforcement learning or Bayesian search. As described above, since the machining control unit 402 includes the machining parameter analyzer 20, the imaging performance can be estimated with high accuracy, and machining can be stably performed. Except for the above-described differences, the operation according to the fourth embodiment is the same as that in the first embodiment.

As described above, the machining parameter analyzer 20 according to the fourth embodiment generates a trained model by learning the correspondence relationship between the machining parameter P1, the optical component position information P3, the laser output information P4, and the temperature information P5 and the imaging performance change amount. Then, at the time of laser machining, the machining parameter analyzer 20 inputs the machining parameter P1, the optical component position information P3, the laser output information P4, and the temperature information P5 to the trained model to estimate the imaging performance change amount. Consequently, since the laser machining apparatus 400 can execute laser machining in consideration of even the change in the imaging performance of the imaging optical system 5, it is possible to sufficiently prevent/reduce deterioration of laser machining quality.

Subsequently, the hardware configuration of the machining control units 102, 202, 302, and 402 will be described. Because the machining control units 102, 202, 302, and 402 have similar hardware configurations, the hardware configuration of the machining control unit 102 will be described here. In the machining control unit 102, the machining parameter input unit 13, the beam characteristic calculation unit 14, the optical component temperature estimation unit 15, the thermal lens estimation unit 16, the imaging performance change estimation unit 17, the correction amount calculation unit 22, and the control unit 11 are implemented by processing circuitry. This processing circuitry may be a memory and a processor that executes a program stored in the memory, or may be dedicated hardware. The processing circuitry is also called a control circuit.

FIG. 10 is a diagram illustrating an exemplary configuration of processing circuitry in the case that the processing circuitry provided in the machining control unit according to the first to fourth embodiments is implemented by a processor and a memory. The processing circuitry 90 illustrated in FIG. 10 is a control circuit and includes the processor 91 and the memory 92. In a case where the processing circuitry 90 is configured with the processor 91 and the memory 92, each function of the processing circuitry 90 is implemented by software, firmware, or a combination of software and firmware. Software or firmware is described as a program and stored in the memory 92. In the processing circuitry 90, the processor 91 reads and executes the program stored in the memory 92, thereby implementing each function. That is, the processing circuitry 90 includes the memory 92 for storing a machining control program that results in the processing of the machining control unit 102. It can also be said that this machining control program is a program for causing the machining control unit 102 to execute each function implemented by the processing circuitry 90. This machining control program may be provided by a storage medium in which the program is stored, or may be provided by other means such as a communication medium.

The processor 91 is exemplified by a central processing unit (CPU), a processing device, an arithmetic device, a microprocessor, a microcomputer, or a digital signal processor (DSP). Examples of the memory 92 include a non-volatile or volatile semiconductor memory, a magnetic disk, a flexible disk, an optical disc, a compact disc, a mini disc, a digital versatile disc (DVD), and the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

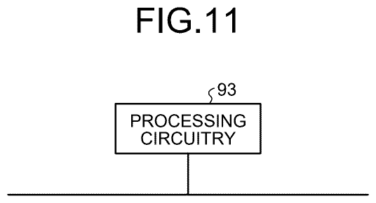

FIG. 11 is a diagram illustrating an example of processing circuitry in the case that the processing circuitry provided in the machining control unit according to the first to fourth embodiments is implemented by dedicated hardware. For example, the processing circuitry 93 illustrated in FIG. 11 is a single circuit, a composite circuit, a programmed processor, a parallel programmed processor, an application specific integrated circuit (ASIC), a field programmable gate array (FPGA), or a combination thereof.

The processing circuitry 90 and 93 may be partially implemented by dedicated hardware, and partially implemented by software or firmware. In this manner, the processing circuitry 90 and 93 can implement the above-described functions using dedicated hardware, software, firmware, or a combination thereof.

Note that the machining parameter input unit 13, the beam characteristic calculation unit 14, the optical component temperature estimation unit 15, the thermal lens estimation unit 16, the imaging performance change estimation unit 17, the correction amount calculation unit 22, and the control unit 11 may be partially implemented by separate pieces of processing circuitry.

The configurations described in the above-mentioned embodiments indicate examples. The embodiments can be combined with another well-known technique and with each other, and some of the configurations can be omitted or changed in a range not departing from the gist.

### REFERENCE SIGNS LIST

1 laser oscillator; 2 optical fiber; 3 machining head; 4 collimator lens; 5 imaging optical system; 6 optical component holder; 7 temperature sensor; 8 protective glass; 9 machining nozzle; 10A to 10C, 10X drive unit; 11 control unit; 12 water passage; 13 machining parameter input unit; 14 beam characteristic calculation unit; 15 optical component temperature estimation unit; 16 thermal lens estimation unit; 17 imaging performance change estimation unit; 18 temperature information initialization time setting unit; 19 correction coefficient determination unit; 20 machining parameter analyzer; 21 data acquisition unit; 22 correction amount calculation unit; 23 feature extraction unit; 24 learning unit; 30 optical component; 90, 93 processing circuitry; 91 processor; 92 memory; 100, 200, 300, 400 laser machining apparatus; 101, 201, 301, 401 laser machining unit; 102, 202, 302, 402 machining control unit; D1, D2 imaging point position; L laser light; P1 machining parameter; P21 material; P22 plate thickness; P23 gas type; P3 optical component position information; P4 laser output information; P5 temperature information; P6 optical component displacement amount; P7 laser output command; W workpiece.

1.-15. (canceled)

16. A laser machining apparatus comprising:
temperature estimation circuitry to estimate an estimated temperature of an optical component based on a beam characteristic of laser light with which an optical component disposed in a machining head is irradiated and temperature information that is information on a temperature measured by a temperature sensor disposed in the machining head;
thermal lens estimation circuitry to estimate a thermal lens amount of the optical component based on the estimated temperature;
imaging performance change estimation circuitry to estimate, based on the thermal lens amount, an estimated imaging performance change amount that is an amount of change in imaging performance of an imaging optical system of the machining head from before start of machining; and
correction amount calculation circuitry to calculate a correction amount of a machining parameter based on the estimated imaging performance change amount.

17. The laser machining apparatus according to claim 16, further comprising:
beam characteristic calculation circuitry to calculate the beam characteristic; and
control circuitry to control laser machining that uses the laser light, and change the machining parameter based on the correction amount during the laser machining.

18. The laser machining apparatus according to claim 17, wherein
the imaging performance change estimation circuitry estimates, as the estimated imaging performance change amount, an amount of change in position of an imaging point of the imaging optical system from before start of machining.

19. The laser machining apparatus according to claim 17, wherein
the temperature estimation circuitry estimates a temperature of the optical component at a plurality of time points in time series, and when estimating a temperature of the optical component, estimates the temperature of the optical component based on a temperature of the optical component at a time point at least one step before a time point of estimation.

20. The laser machining apparatus according to claim 17, wherein
when a laser output value of the laser light is less than a specific value for a specific period of time, the temperature estimation circuitry updates the temperature information measured by the temperature sensor to latest temperature information, and estimates the estimated temperature based on the latest temperature information and the beam characteristic.

21. The laser machining apparatus according to claim 17, further comprising
a correction coefficient determination circuitry to determine a correction coefficient for correcting the estimated imaging performance change amount based on machining type information indicating type of the laser machining, wherein
the correction amount calculation circuitry corrects the estimated imaging performance change amount using the correction coefficient, and calculates the correction amount based on the estimated imaging performance change amount after correction.

22. The laser machining apparatus according to claim 21, wherein
the machining type information includes at least one of material of a workpiece, plate thickness of the workpiece, and type of machining gas that is used for the laser machining.

23. The laser machining apparatus according to claim 17, wherein
the temperature sensor is attached to a holding circuitry that holds the optical component.

24. The laser machining apparatus according to claim 17, wherein
the temperature estimation circuitry includes a first machine learning device, and
the first machine learning device includes:
first data acquisition circuitry to acquire first state quantities including first temperature information in the temperature information and a first beam characteristic in the beam characteristic; and
first learning circuitry to generate a first trained model by learning to estimate the estimated temperature based on the first state quantities, and based on first trained model and second state quantities including second temperature information in the temperature information and a second beam characteristic in the beam characteristic, estimate the estimated temperature corresponding to the second state quantities.

25. The laser machining apparatus according to claim 17, wherein
the thermal lens estimation circuitry includes a second machine learning device, and
the second machine learning device includes:
second data acquisition circuitry to acquire third state quantities including a first estimated temperature in the estimated temperature; and
second learning circuitry to generate a second trained model by learning to estimate the thermal lens amount based on the third state quantities, and based on the second trained model and fourth state quantities including a second estimated temperature in the estimated temperature, estimate the thermal lens amount corresponding to the fourth state quantities.

26. The laser machining apparatus according to claim 17, wherein
the imaging performance change estimation circuitry includes a third machine learning device, and
the third machine learning device includes:
third data acquisition circuitry to acquire fifth state quantities including a first thermal lens amount in the thermal lens amount; and
third learning circuitry to generate a third trained model by learning to estimate the estimated imaging performance change amount based on the fifth state quantities, and based on the third trained model and sixth state quantities including a second thermal lens amount in the thermal lens amount, estimate the estimated imaging performance change amount corresponding to the sixth state quantities.

27. The laser machining apparatus according to claim 17, wherein
the correction amount calculation circuitry includes a fourth machine learning device, and
the fourth machine learning device includes:
fourth data acquisition circuitry to acquire seventh state quantities including a first estimated imaging performance change amount in the estimated imaging performance change amount; and
fourth learning circuitry to generate a fourth trained model by learning to estimate the correction amount based on the seventh state quantities, and based on the fourth trained model and eighth state quantities including a second estimated imaging performance change amount in the estimated imaging performance change amount, estimate the correction amount corresponding to the eighth state quantities.

28. A control device comprising:
beam characteristic calculation circuitry to calculate a beam characteristic of laser light with which an optical component disposed in a machining head is irradiated;
temperature estimation circuitry to estimate an estimated temperature of the optical component based on the beam characteristic and temperature information that is information on a temperature measured by a temperature sensor disposed in the machining head;
thermal lens estimation circuitry to estimate a thermal lens amount of the optical component based on the estimated temperature;
imaging performance change estimation circuitry to estimate, based on the thermal lens amount, an estimated imaging performance change amount that is an amount of change in imaging performance of an imaging optical system of the machining head from before start of machining;
correction amount calculation circuitry to calculate a correction amount of a machining parameter based on the estimated imaging performance change amount; and
control circuitry to control laser machining that uses the laser light, and change the machining parameter based on the correction amount during the laser machining.

29. A laser machining system comprising:
a laser machining device to irradiate a workpiece with laser light from a machining head in which an optical component is disposed to perform laser machining on the workpiece; and
a machining controller to control the laser machining device, wherein
the laser machining device includes:
a laser oscillator to oscillate the laser light; and
a temperature sensor disposed in the machining head to measure a temperature in the machining head, and
the machining controller includes:
beam characteristic calculation circuitry to calculate a beam characteristic of the laser light with which the optical component is irradiated;
temperature estimation circuitry to estimate an estimated temperature of the optical component based on the beam characteristic and temperature information that is information on a temperature measured by the temperature sensor;
thermal lens estimation circuitry to estimate a thermal lens amount of the optical component based on the estimated temperature;
imaging performance change estimation circuitry to estimate, based on the thermal lens amount, an estimated imaging performance change amount that is an amount of change in imaging performance of an imaging optical system of the machining head from before start of machining;
correction amount calculation circuitry to calculate a correction amount of a machining parameter based on the estimated imaging performance change amount; and
control circuitry to control the laser machining that uses the laser light, and change the machining parameter based on the correction amount during the laser machining.

30. A laser machining method comprising:
irradiating a workpiece with laser light from a machining head in which an optical component is disposed to perform laser machining on the workpiece; and
controlling the laser machining device, wherein
the irradiating includes:
oscillating the laser light; and
measuring a temperature in the machining head, and
the controlling includes:
calculating a beam characteristic of the laser light with which the optical component is irradiated;
estimating an estimated temperature of the optical component based on the beam characteristic and temperature information that is information on a temperature measured;
estimating a thermal lens amount of the optical component based on the estimated temperature;
estimating, based on the thermal lens amount, an estimated imaging performance change amount that is an amount of change in imaging performance of an imaging optical system of the machining head from before start of machining;
calculating a correction amount of a machining parameter based on the estimated imaging performance change amount; and
controlling the laser machining that uses the laser light, and changing the machining parameter based on the correction amount during the laser machining.
